(19) United States
(12) Patent Application Publication
(10) Pub. No.: US 2013/0200884 A1
(43) Pub. Date: Aug. 8, 2013

(54) POSITION SENSOR

(71) Applicant: AISAN KOGYO KABUSHIKI KAISHA, Obu-shi (JP)

(72) Inventors: Yuichi MANABE, Inazawa-shi (JP); Tetsuji INOUE, Nagoya-shi (JP)

(73) Assignee: AISAN KOGYO KABUSHIKI KAISHA, Obu-shi (JP)

(21) Appl. No.: 13/754,332

(22) Filed: Jan. 30, 2013

(30) Foreign Application Priority Data
Feb. 8, 2012 (JP) 2012-025560
Nov. 5, 2012 (JP) 2012-243758

(51) Int. Cl. G01B 7/14

(52) U.S. Cl. CPC G01B 7/14
USPC 324/207.16

(57) ABSTRACT

A position sensor includes: a stator including an excitation coil and a detection coil each formed in planar shape; and a mover placed to face the stator and provided with a plurality of regions having different magnetic permeability and being arranged periodically in a moving direction of the mover. The excitation coil includes a first excitation coil pattern and a second excitation coil pattern formed adjacent to the first excitation coil pattern. The detection coil includes a detection coil pattern placed between the first excitation coil pattern and the second excitation coil pattern in the moving direction of the mover. The second excitation coil pattern is wound to flow an excitation current in an opposite direction to the first excitation coil pattern.

### CROSS-REFERENCE TO RELATED APPLICATIONS

This application is based upon and claims the benefit of priority from the prior Japanese Patent Applications Nos. 2012-025560 filed Feb. 8, 2012 and 2012-243758 filed Nov. 5, 2012, the entire contents of which are incorporated herein by reference.

### BACKGROUND OF THE INVENTION

1. Field of the Invention

The present invention relates to a position sensor to be used to detect an operation position of a mover, the position sensor including a stator fixing substrate on which a stator coil is formed and the mover provided movably while facing the stator fixing substrate with a gap therefrom.

2. Related Art

As a technique of the above type, heretofore, there for example rotation angle sensors widely available in various fields. Engines mounted on vehicles adopt a crank angle sensor which is one of the rotation angle sensors in order to detect rotation speed and rotation phase of the engine.

Patent Document 1 discloses a technique related to a position detecting sensor for a linear pulse motor. This sensor is configured such that an excitation coil and a detection coil are placed in overlapping manner on a mover to detect positional displacement with respect to a stator made of a comb-like magnetic material. Based on output fluctuation or variation from the detection coil, the position of the mover is detected.

Patent Document 2 discloses a technique related to a resolver. This is a phase-difference resolver including an excitation coil to be applied with an excitation signal and a detection coil to detect a detection signal in order to detect a displacement amount based on the detection signal varying with the displacement amount of a passive element on which the excitation coil or detection coil is provided. This resolver adopts a method to obtain a detection signal by detecting (demodulating) a modulated signal formed by modulation of a high-frequency signal by an excitation signal input to the excitation coil.

Patent Document 3 discloses a technique related to a rotation angle detecting sensor. This sensor includes an encoder structure provided with a rotor and a conductive pattern attached to be rotatable together with the rotor and configured to cyclically change the width of the conductive pattern, and a sensor main body provided with a plurality of inductance elements and placed to face the encoder structure with a gap therefrom. With the encoder structure provided with the simplified conductive pattern, a reduced manufacturing cost of the encoder structure can be expected more than the technique of Patent Document 1.

### RELATED DOCUMENTS

### Patent Documents

Patent Document 1: JP-A-61(1986)-226613

Patent Document 2: JP-A-2000-292205

Patent Document 3: JP-A-2009-128312

### SUMMARY OF INVENTION

### Problems to be Solved by the Invention

However, when the techniques of Patent Documents 1 to 3 are used in the position sensors, the following problems may occur.

A position sensor, particularly, a position sensor such as a crank angle sensor mounted on a vehicle, is demanded for size reduction and high accuracy. For the position sensors using the techniques of Patent Documents 1 to 3, it is conceived that a sheet-type coil is made from a printed substrate, but this configuration has a limitation in downsizing. To solve this problem, the present applicants have proposed a method for forming coils on an insulating substrate by ink jet printing. However, this method has a common problem that detection output is large to some extent even when a magnetic body and the coils do not face each other, and thus an amplitude ratio decreases. This method does not meet the demand of the position sensor for high accuracy.

The present invention has been made to solve the above problems and has a purpose to provide a position sensor configured to achieve a high amplitude ratio.

### Means of Solving the Problems

(1) To achieve the above purpose, one aspect of the invention provides a position sensor comprising: a stator including an excitation coil and a detection coil each formed in planar shape; and a mover placed to face the stator and provided with a plurality of regions having different magnetic permeability from each other and being arranged periodically in a moving direction of the mover, wherein the excitation coil includes a first excitation coil pattern and a second excitation coil pattern formed adjacent to the first excitation coil pattern, the detection coil includes a detection coil pattern placed between the first excitation coil pattern and the second excitation coil pattern in the moving direction of the mover, and the second excitation coil pattern is wound to flow an excitation current in an opposite direction to the first excitation coil pattern.

According to the above configuration (1), the detection accuracy of the position sensor can be improved. Specifically, the detection coil pattern is placed between the first excitation coil pattern and the second excitation coil pattern in the moving direction of the mover, the first excitation coil pattern and the second excitation coil pattern are opposite in coil winding direction, allowing excitation current to flow in opposite directions. Thus, variation of the density of magnetic flux passing a strong magnetic region can be increased according to movement of the mover.

To be concrete, for example, in a state where only the first excitation coil pattern overlaps or faces a magnetic region, electric current occurs in the detection coil pattern in the same direction as the winding direction of the first excitation coil pattern by the Right-handed screw law. In a state where only the second excitation coil pattern faces a high magnetic region, excitation currents in the first excitation coil pattern and the second excitation coil pattern flow in the opposite directions to each other. Thus, in the detection coil pattern, electric current occurs in the opposite direction to that when the first excitation coil pattern faces the high magnetic region. Accordingly, the amplitude ratio of electric current generated in the detection coil can be increased. This can achieve improved detection accuracy of the position sensor.

(2) In the position sensor described in (1), preferably, the first excitation coil pattern and the second excitation coil pattern include wire portions facing to each other, the wire portions being located in positions overlapping part of wiring portions of the detection coil pattern by interposing an insulation layer.

According to the above configuration (2), the distance between the detection coil and the excitation coil can be made shortest. This increases current output to be detected by the detection coil. This results in an increased S/N ratio of the position sensor, contributing to improvement of accuracy of the position sensor.

(3) The position sensor described in (1) or (2) preferably further includes a coupling part to add an excitation signal component applied to the excitation coil to a detection signal to be detected by the detection coil; and an envelope detector circuit connected to the detection coil, wherein the position sensor is configured to detect an angle of the mover based on an envelope signal obtained by the detection signal from the detection coil by passing through the envelop detector circuit.

According to the above configuration (3), electric current to be detected by the detection coil can be offset. The first excitation coil pattern and the second excitation coil pattern are connected electrically by a connecting line, so that the electric current also flow through the connecting line, generating a magnetic field. The magnetic flux density of this magnetic field is enhanced in the high magnetic region, and thus an electromotive force occurs in the detection coil. By the occurrence of this electromotive force, the offset effect can be generated in a current waveform generated in the detection coil. Even when the effect of a magnetic flux generated from either of the first excitation coil pattern and the second excitation coil pattern is greatly influenced by either of the first excitation coil pattern and the second excitation coil pattern, the current waveform generated in the detection coil does not reverse. This facilitates signal processing. As a result, a simple circuit configuration and reduced cost can be achieved.

(4) The position sensor described in (3) preferably further includes an adjustment circuit placed following the envelop detector circuit to adjust an offset value of a resultant signal of addition of the excitation signal component.

In a case where the position sensor includes a plurality of detection coils, there is a limit in manufacturing accuracy of the detection coil patterns. Thus, fine adjustment of offset values may be difficult. The above configuration (4) additionally including the adjustment circuit can also treat such a difficult case and contribute to improvement of detection accuracy of the position sensor.

(5) In the position sensor described in one of (1) to (4), preferably, the excitation coil and the detection coil are formed on a flexible printed substrate, a magnetic material layer is formed on an opposite side of the flexible printed substrate from a side on which the excitation coil and the detection coil are formed, and the magnetic material layer is covered by a resin film.

According to the above configuration (5), the magnetic material layer serves as a back yoke, whereby enhancing the density of magnetic flux to be generated in the excitation coil. This results in improvement of detection accuracy of the position sensor.

(6) Another aspect of the invention provides a position sensor comprising: a stator on which an excitation coil and a detection coil each formed in planar shape and placed one on the other; and a mover placed to face the stator, the mover being formed with a surface facing the stator so that the surface provides varying magnetic permeability in a moving direction, the excitation coil includes a first excitation coil pattern and a second excitation coil pattern that are wound to flow excitation current to flow in opposite directions to each other, the detection coil includes a first detection coil pattern placed between the first excitation coil pattern and the second excitation coil pattern in the moving direction of the mover, the first detection coil pattern outputs a signal varying according to coupling change between the first detection coil pattern and the first and second excitation coil patterns according to movement of the mover, wherein the position sensor further includes a first coupling part where a first connecting wire connecting the first detection coil pattern to a first output terminal runs in parallel to the first excitation coil pattern.

The above configuration described in (6) is based on the configuration described in (1). Specifically, in the position sensor described in (1), the planar excitation coil and the planar detection coil are provided by lamination, and the position sensor has the function of varying the output of the first detection coil pattern by coupling change of the first detection coil pattern with respect to the first and second excitation coil patterns according to the movement of the mover. This position sensor also includes the first coupling part in which the first connecting wire that connects the first detection coil pattern to the first output terminal runs in parallel to the first excitation coil pattern.

According to the configuration described in (6), an output amplitude to be detected by the detection coil can be offset. To be concrete, the following operations and effects are achieved. The first detection coil pattern is placed to overlap the first excitation coil pattern and the second excitation coil pattern. The first detection coil pattern forms three coupling parts in cooperation with the first and second excitation coil patterns. One is a left side coupling part formed by the first detection coil pattern and the first excitation coil pattern. Another is a right side coupling part formed by the first detection coil pattern and the second excitation coil pattern. The remaining one is a first coupling part formed by the connecting wire and the first excitation coil pattern.

The first and second excitation coil patterns are wound to flow excitation currents in mutually opposite directions. Thus, the left side coupling part and the right side coupling part can generate reverse electromotive forces. On the other hand, since the first coupling part generates an electromotive force in the same direction as in the left side coupling part, the electromotive force generated in the first coupling part can provide an effect to raise the level of electromotive force to be obtained from the left coupling part, that is, an offset effect, to the current waveform generated in the detection coil. Specifically, the position sensor uses, for position detection, wire portions of the first and second excitation coil patterns, placed in a direction perpendicular to the moving direction of the mover. The electromotive force generated in the first coupling part can be used for offset of the current waveform.

As above, the offset effect can be achieved by a relatively simple method that the first connecting wire is placed to extend in parallel to the first excitation coil pattern. The offset value can be adjusted by changing the length of the first connecting wire. Accordingly, the output waveform is made offset and detected by a simple circuit configuration, so that a sine wave-shaped output is obtained. Consequently, cost reduction of the position sensor can be achieved.

(7) In the position sensor described in (6), preferably, the excitation coil includes a third excitation coil wound to flow excitation current in an opposite direction to the second excitation coil pattern, the detection coil includes a second detection coil pattern placed between the second excitation coil pattern and the third excitation coil pattern in the moving direction of the mover, the second detection coil pattern outputs a signal varying according to coupling change between the second detection coil pattern and the second and third excitation coil patterns according to movement of the mover, and the position sensor further includes a second coupling part where a second connecting wire connecting the second detection coil pattern to a second output terminal runs in parallel to the second excitation coil pattern.

According to the above configuration (7), the other side of the second excitation coil pattern can be used for the second detection coil. The first and second excitation coil patterns, and the second and third excitation coil patterns, are configured to flow electric currents in mutually opposite directions. Under the influence of the magnetic fields formed by the second excitation coil pattern and the third excitation coil pattern, the second detection coil pattern can obtain an electromotive force. At that time, furthermore, the offset effect can be achieved by the electromotive force obtained from the second coupling part. As above, the right side and the left side of the second excitation coil pattern can generate electromotive forces in the first and second detection coil patterns. This can realize space saving, leading to a compact position sensor.

(8) Furthermore, in the position sensor described in (7), preferably, a coupling amount between the first connecting wire and the first excitation coil in the first coupling part and a coupling amount between the second connecting wire and the second excitation coil pattern in the second coupling part are different from each other.

The first, second, and third excitation coil patterns and the first and second detection coil patterns are formed of coils each having a small number of turns. Accordingly, a slight difference in wire length between coil patterns influences the detection signal, which may affect detection accuracy. However, the first connecting wire and the second connecting wire are set to respective arbitral lengths, and a coupling amount of the first connecting wire and the first excitation coil pattern and a coupling amount of the second connecting wire and the second excitation coil pattern are set to be different from each other, whereby enabling the coil side to adjust variation of the output amplitude. Therefore, a manufacturing cost of the position sensor can be reduced.

(9) In the position sensor described in (6), preferably, the excitation coil includes a Z-phase excitation coil provided with a Z-phase first excitation coil pattern and a Z-phase second excitation coil pattern, the detection coil includes a Z-phase detection coil provided with a Z-phase detection coil pattern, the mover includes, on a mover substrate made of non-magnetic metal and on a surface facing the Z-phase detection coil, a Z-phase detecting region having a different magnetic permeability from a magnetic permeability of the mover substrate and Z-phase preliminary detecting regions having a different magnetic permeability from the magnetic permeability of the mover substrate, and the Z-phase preliminary detecting regions are placed on both sides of the Z-phase detecting region in the moving direction of the mover.

According to the above configuration (9), errors of the Z-phase signal can be reduced. This is achieved by the Z-phase preliminary detecting regions placed on both sides of the Z-phase detecting region arranged to detect a trigger signal. If the Z-phase detecting region is provided alone, the trigger signal detected by the Z-phase detection coil smoothly rises. This may cause a timing delay in detecting the trigger signal. However, the above configuration includes the Z-phase preliminary detecting regions on both sides of the Z-phase detecting region, so that a dummy trigger signal is detected when the Z-phase detection coil detects the Z-phase preliminary detecting region. Thereafter, the Z-phase detection coil detects the trigger signal in the Z-phase detecting region.

At that time, a falling edge of the dummy trigger signal by the immediate preceding Z-phase preliminary detecting region is detected, so that the trigger signal sharply rises. Consequently, a detection signal of the trigger signal is less likely to delay. This enhances the detection accuracy of the trigger signal, contributing improvement of accuracy of the position sensor.

### BRIEF DESCRIPTION OF THE DRAWINGS

FIG. 1 is a schematic perspective view of a rotary encoder in a first embodiment;

FIG. 2 is a perspective view of a stator in the first embodiment;

FIG. 3 is a schematic view showing a correspondence relationship between a detection coil, an excitation coil, and a rotor pattern in the first embodiment;

FIG. 4 is a schematic cross sectional view of a flexible printed substrate and a back yoke in the first embodiment;

FIG. 5 is a schematic perspective view showing the back yoke in the first embodiment;

FIG. 6 is a detection block diagram of the rotary encoder in the first embodiment;

FIG. 7 is a graph showing output waveforms in the first embodiment;

FIG. 8a is a schematic view showing a positional relationship between a rotor and a stator in the first embodiment;

FIG. 8b is a graph showing output waveforms in FIG. 8a;

FIG. 9a is a schematic view showing a positional relationship between the rotor and the stator in the first embodiment;

FIG. 9b is a graph showing output waveforms in FIG. 9a;

FIG. 10a is a schematic view showing a positional relationship between the rotor and the stator in the first embodiment;

FIG. 10b is a graph showing output waveforms in FIG. 10a;

FIG 11a is a schematic view showing a positional relationship between the rotor and the stator in the first embodiment;

FIG 11b is a graph showing output waveforms in FIG. 11a;

FIG. 12 is an equivalent circuit diagram for the excitation coil and the detection coil in the first embodiment;

FIG. 13 is a detection block diagram of a rotary encoder in a second embodiment;

FIG. 14 is a conceptual diagram of an adjustment circuit in the second embodiment;

FIG. 15 is a detection block diagram of a rotary encoder in a third embodiment;

FIG. 16 is a plan view of a detection coil in a fourth embodiment;

FIG. 17 is a plan view of an excitation coil in the fourth embodiment;

FIG. 18 is a plan view showing a state where the detection coil and the excitation coil are placed in overlapping manner in the fourth embodiment;

FIG. 19 is a plan view showing correspondence between the detection coil, the excitation coil, and the rotor pattern in the fourth embodiment;

FIG. 20 is a detection block diagram of a rotary encoder in the fourth embodiment;

FIG. 21 is an equivalent circuit diagram for the excitation coil and the detection coil in the fourth embodiment;

FIG. 22 is a schematic diagram showing a Z-phase pattern configuration in a fifth embodiment, in which (a) is a plan view of a Z-phase detection coil, (b) is a plan view of a Z-phase excitation coil, and (c) is a plan vie of a rotor pattern;

FIG. 23 is a graph showing output waveforms from the Z-phase detection coil in the fifth embodiment; and

FIG. 24 is a graph showing output waveforms from a Z-phase detection coil for comparison.

### DESCRIPTION OF EMBODIMENTS

A detailed description of a first preferred embodiment of the present invention applied to a rotary encoder to be provided for a crank shaft of a vehicle to detect the rotation angle of crank will now be given referring to the accompanying drawings.

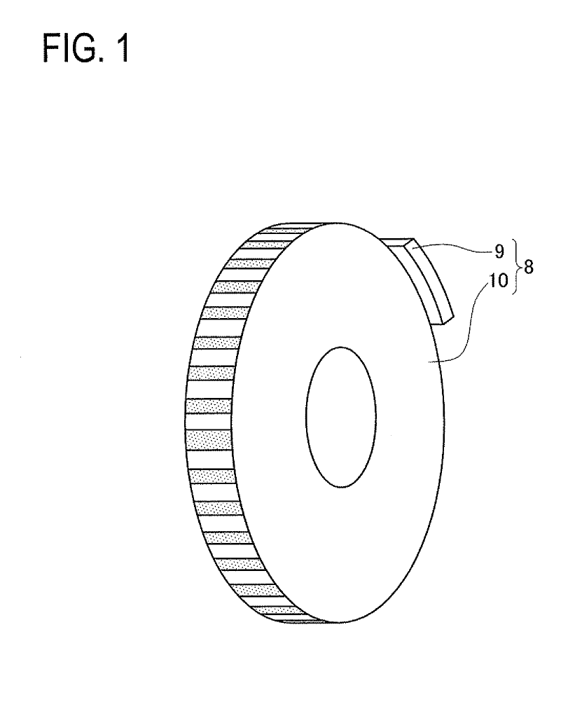

FIG. 1 is a schematic perspective view of a rotary encoder 8 in the first embodiment. This rotary encoder 8 which is one type of position sensors includes a rotor 10 serving as a mover mounted on a rotary shaft not shown and a stator 9 serving as a stator fixed to face a part of the outer periphery of the rotor 10. The rotor 10 is preferably made of a non-magnetic conductive metal. The rotor 10 in the present embodiment is therefore formed of a cylindrical element made of non-magnetic stainless steel having an outer diameter of 80 mm and a width (i.e., thickness) of 10 mm in the present embodiment. The material is selectable from any non-magnetic and conductive metals. For example, aluminum and others may also be selected.

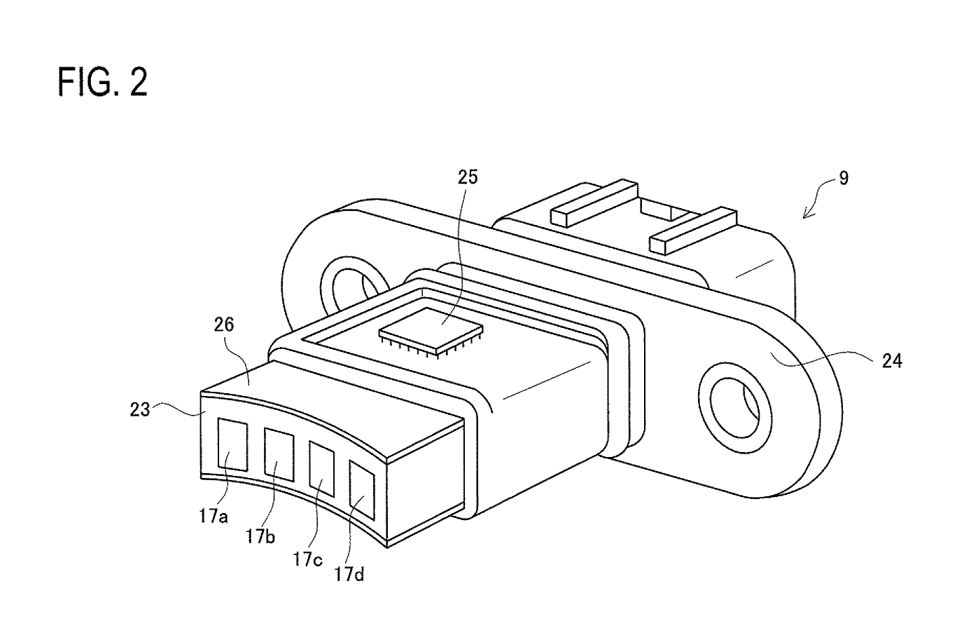

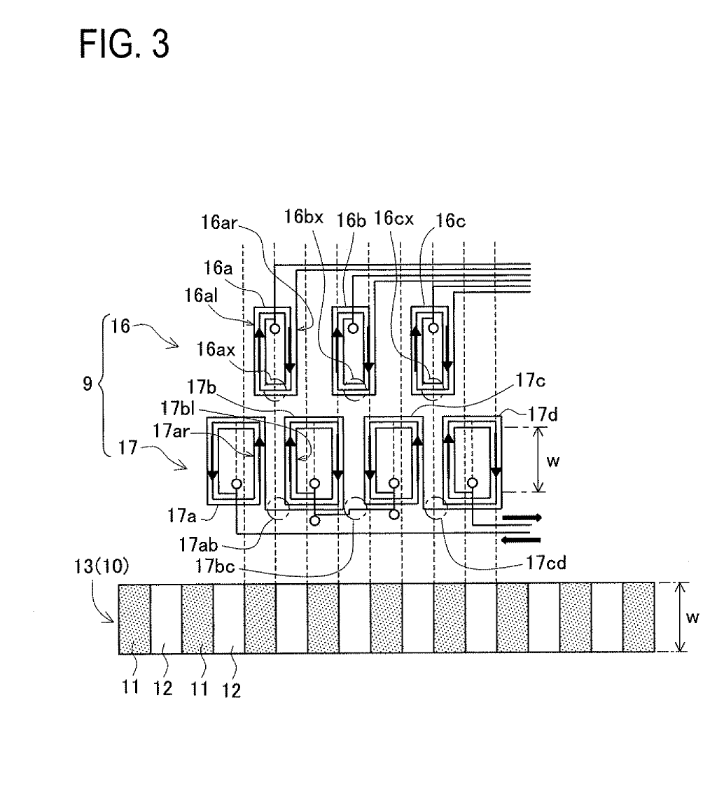

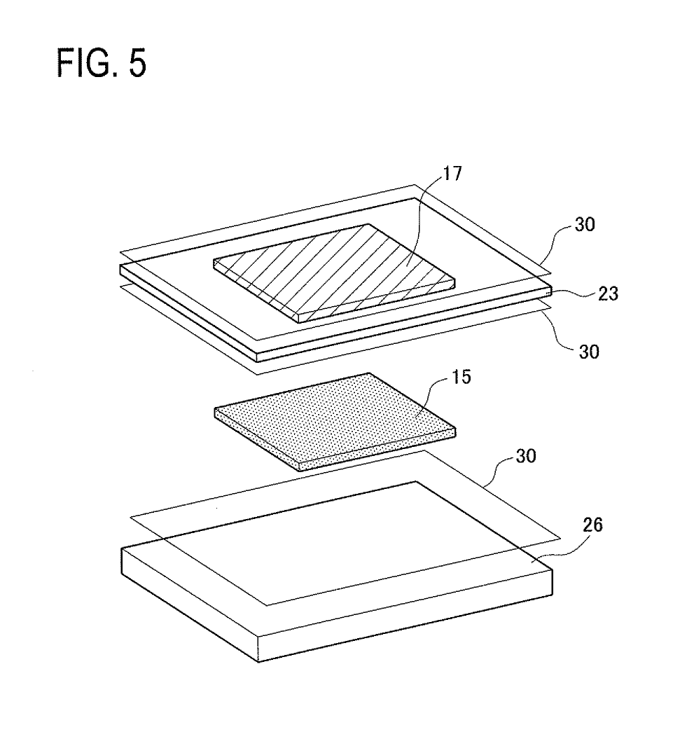

FIG. 2 is a perspective view of the stator 9. FIG. 3 is a schematic diagram showing a correspondence relationship between a detection coil 16, an excitation coil 17, and a rotor pattern 13. FIG. 5 is a schematic perspective view showing a flexible printed substrate 23 and a back yoke 15. The rotor pattern 13 is formed on the outer peripheral surface of the rotor 10. The detection coil 16 and the excitation coil 17 are illustrated in planar form in FIG. 3 to facilitate understanding of the correspondence relationship. The rotor pattern 13 formed on the surface of the rotor 10 includes non-magnetic sections 12 made of non-magnetic metal, thereby forming non-magnetic conductive regions, and magnetic sections 11 made of magnetic material such as ferrite. These non-magnetic sections 12 and the magnetic sections 11 are alternately arranged.

The magnetic sections 11 are formed in such a manner that the magnetic material prepared by mixing magnetic powder such as ferrite and a resin binder is applied on the outer peripheral surface of the rotor 10 by screen printing. On the other hand, the non-magnetic sections 12 which are the non-magnetic conductive regions correspond to bare metal portions of the rotor 10 on which the magnetic material is not applied. In other words, the magnetic sections 11 are formed with a predetermined width and at predetermined intervals in a circumferential direction of the rotor 10 to form the stripe rotor pattern 13 on the outer peripheral surface of the rotor 10. Thus, the magnetic sections 11 and the non-magnetic sections 12 provide regions having different magnetic characteristics (regions having different magnetic permeability) are on the outer peripheral surface of the rotor 10.

The stator 9 is configured as shown in FIG. 2 such that a flange-shaped mounting member 24 is fixed to a stator main body 26. Furthermore, a circuit member 25 is attached to the upper surface of the stator main body 26. In a finished product as the stator 9, the circuit member 25 is covered with a molding material and thus is invisible. For convenience in explaining, however, the molding material is omitted from FIG. 2. A flexible printed substrate 23 is provided on a front end face of the stator main body 26. On the surfaces of this flexible printed substrate 23, the detection coil 16 and the excitation coil 17 are provided. The back yoke 15 shown in FIG. 5 is coated with a mixture of magnetic powder and a resin binder, as with the magnetic sections 11, and placed below the detection coil 16 by interposing a P1 film (polyimide film) 30 therebetween. The back yoke 15 is designed with a width enough to cover the excitation coil 17. In FIG. 2, the coil pattern of the excitation coil 17 appears.

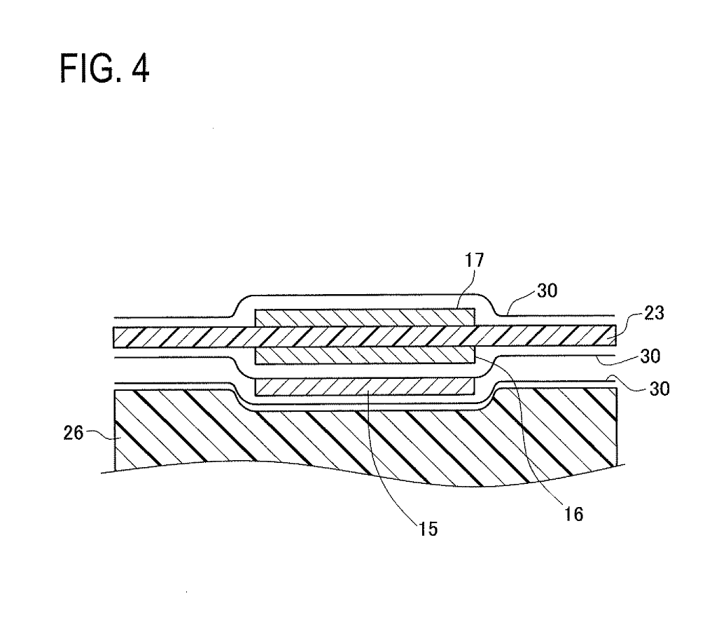

The detection coil 16 and the excitation coil 17 are formed one on each surface of the flexible printed substrate 23 of the stator 9. FIG. 4 is a schematic cross sectional view of the flexible printed substrate 23 and the back yoke 15. On the flexible printed substrate 23, the detection coil 16 and the excitation coil 17 are laminated separately. In FIG. 4, the excitation coil 17 is formed on an upper surface of the flexible printed substrate 23 and covered with a PI film 30 laminated thereon. The detection coil 16 is formed on a lower surface of the same substrate 23 and covered with another PI film 30 laminated thereon. The back yoke 15 is also coveted with another PI film 30. Accordingly, the back yoke 15, the detection coil 16, and the stator main body 26 are isolated from each other by the PI films 30. It is to be noted that, in FIG. 4, a gap appears between the PI film 30 and the stator main body 26 for convenience of explanation, but the PI film 30 and the stator main body 26 are actually in close contact with each other.

The detection coil 16 includes a first detection coil pattern 16a, a second detection coil pattern 16b, and a third detection coil pattern 16c as shown in FIG. 3. These patterns 16a, 16b, and 16c are arranged at equal intervals and each formed of a printed coil wound in the same direction, i.e., clockwise in FIG. 3. The intervals of the patterns 16a-16c of the detection coil 16 are determined so that a distance between the centers of adjacent patterns is as large as 2.5 times the width of each magnetic section 11 of the rotor pattern 13.

The excitation coil 17 includes a first excitation coil pattern 17a, a second excitation coil pattern 17b, a third excitation coil pattern 17c, and a fourth excitation coil pattern 17d. The first and third patterns 17a and 17c are coil patterns each wound counterclockwise. The second and fourth patterns 17b and 17d are coil patterns each clockwise wound. Accordingly, the excitation coil 17 is constituted of coil patterns having alternately different turn directions.

A winding start of the first excitation coil pattern 17a and a winding end of the second excitation coil pattern 17b are connected to each other in a connecting portion 17ab. A winding start of the second excitation coil pattern 17b and a winding end of the third excitation coil pattern 17c are connected to each other in a connecting portion 17bc. A winding start of the third excitation coil pattern 17c and a winding end of the fourth excitation coil pattern 17d are connected in a connecting portion 17cd. The first to fourth excitation coil patterns 17a to 17d are arranged at equal intervals. This interval conforms to that of the detection coil 16.

A positional relationship between the detection coil 16 and the excitation coil 17 will be explained below. The first detection coil pattern 16a is located between the first excitation coil pattern 17a and the second excitation coil pattern 17b so that wire portions of the pattern 16a overlap one side of the first pattern 17a and one side of the second pattern 17b respectively.

The second detection coil pattern 16b is located between the second excitation coil pattern 17b and the third excitation coil pattern 17c so that wire portions of the pattern 16b overlap the other side of the second pattern 17b and one side of the third pattern 17c, respectively.

The third detection coil pattern 16c is located between the third excitation coil pattern 17c and the fourth excitation coil pattern 17d so that wire portions of the pattern 16c overlap the other side of the third pattern 17c and one side of the fourth pattern 17d, respectively.

Specifically, the detection coil 16 is configured with its wire portions overlapping the coil patterns of the excitation coil 17. As shown in FIG. 3, the first excitation coil pattern 17a and the third excitation coil pattern 17c are designed to allow electric current to flow in the same direction through respective wire portions overlapping the detection coil 16. Furthermore, the second excitation coil pattern 17b and the fourth excitation coil pattern 17d are designed to allow electric current to flow in opposite directions through respective wire portions overlapping the detection coil 16.

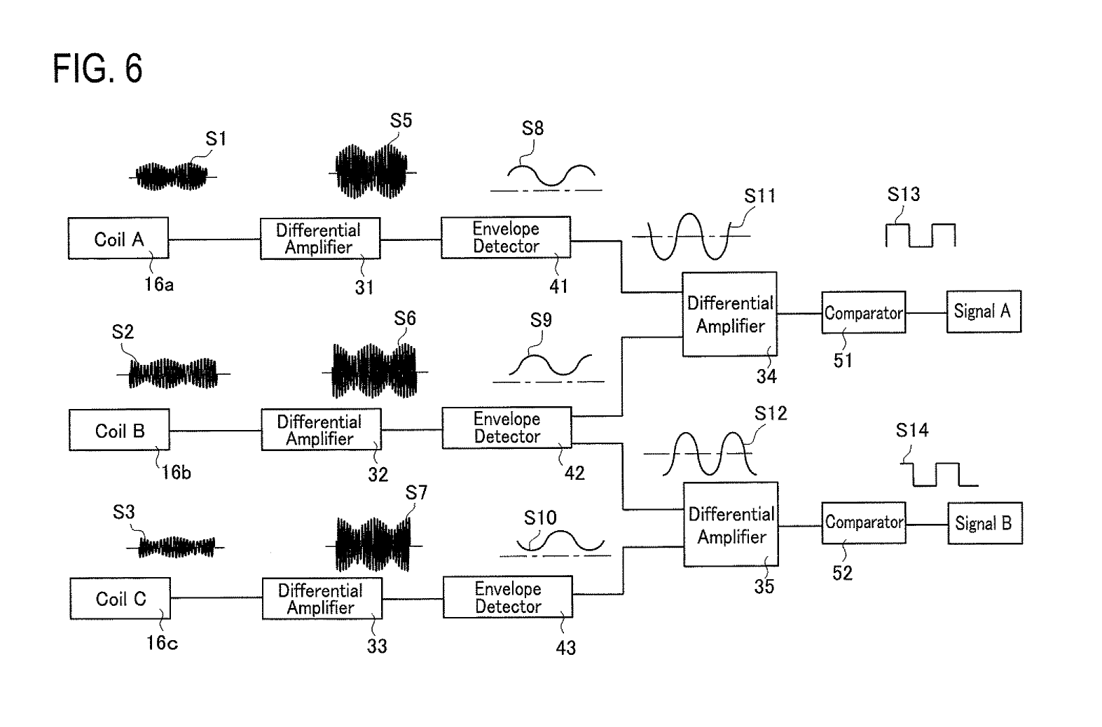

FIG. 6 is a detection block diagram of the rotary encoder 8 of the present embodiment. A high-frequency sine wave of 2 MHz is input to the excitation coil 17. This configuration can reduce the number of turns of the excitation coil 17. A terminal of the first detection coil pattern 16a is connected to a differential amplifier 31 to input a signal S1 to the differential amplifier 31. The differential amplifier 31 differentially amplifies the signal S1 to generate a signal S5. A terminal of the second detection coil pattern 16b is connected to a differential amplifier 32 to input a signal S2 to the differential amplifier 32. A terminal of the third detection coil pattern 16c is connected to a differential amplifier 33 to input a signal S3 to the differential amplifier 33. These signals S2 and S3 are also differentially amplified respectively by the differential amplifiers 32 and 33. Thus, the differential amplifier 32 generates a signal S6 and the differential amplifier 33 generates a signal S7.

An outer envelope of the high-frequency signal S5 obtained from the differential amplifier 31 is detected by an envelope detector 41, which generates a signal S8. Similarly, the high-frequency signal S6 obtained from the differential amplifier 32 and the high-frequency signal S7 obtained from the differential amplifier 33 are respectively input to an envelope detector 42 and an envelope detector 43, which generate a signal S9 and a signal S10. The high-frequency signal S9 of the envelop detector 42 is shifted or displaced in phase by 90° from the high-frequency signal S8 of the envelop detector 41. The high-frequency signal S10 of the envelop detector 43 is shifted in phase by 180° from the high-frequency signal S8 of the envelop detector 41. This is because, as shown in FIG. 3, the second detection coil pattern 16b is arranged with a displacement of half cycle with respect to the first detection coil pattern 16a, and the third detection coil pattern 16c is arranged with a displacement of another half cycle.

The output waveform S8 of the envelop detector 41 and the output waveform S9 of the envelop detector 42 are input to a differential amplifier 34, which differentially amplifies these output waveforms S8 and S9 and generates a signal S11. This signal S11 is input to a comparator 51, which generates a pulse signal S13. The output waveform S9 of the envelop detector 42 and the output waveform S 10 of the envelop detector 43 are input to a differential amplifier 35, which differentially amplifies these output waveforms S9 and S10 and generates a signal S12. This signal S12 is input to a comparator 52, which generates a pulse signal S14. Based on those pulse signals S13 and S14, a rotation angle of the rotor 10 with respect to the stator 9 can be calculated.

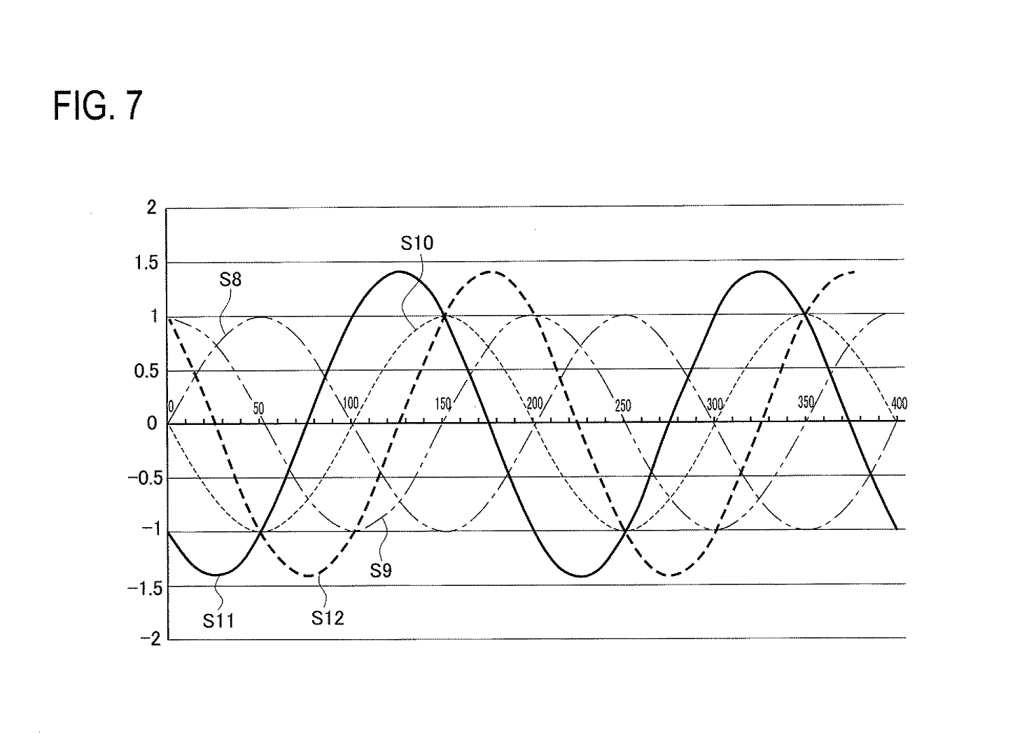

FIG. 7 is a graph showing all the above waveforms. The signal S8 has a waveform of Sin θ, the signal S9 has a waveform of Sin(θ+90), and the signal S10 has a waveform of Sin(θ+180). The signal S11 obtained in the differential amplifier 34 that takes a difference between the signal S9 and the signal S8 is Sin(θ+90)−Sin θ. A waveform with a phase shift of 225° can be obtained. On the other hand, the signal S12 obtained in the differential amplifier 35 that adopts a difference between the signal S10 and the signal S9 is Sin(θ+180)−Sin(θ+90), a waveform with a phase shift of 135° can be obtained.

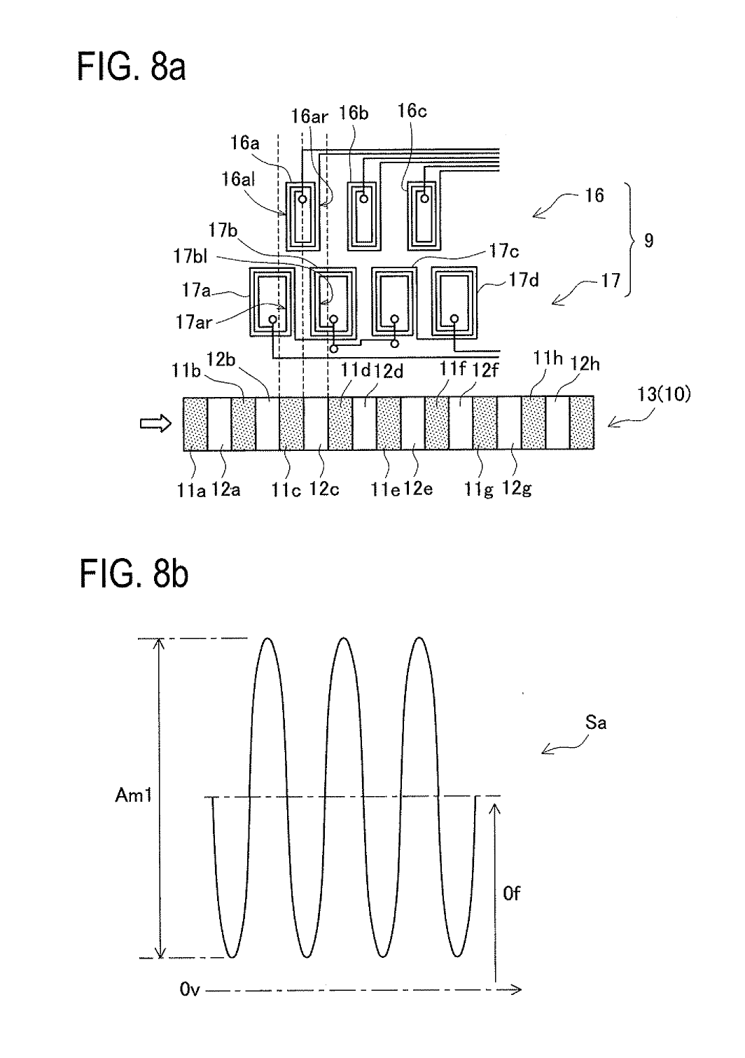

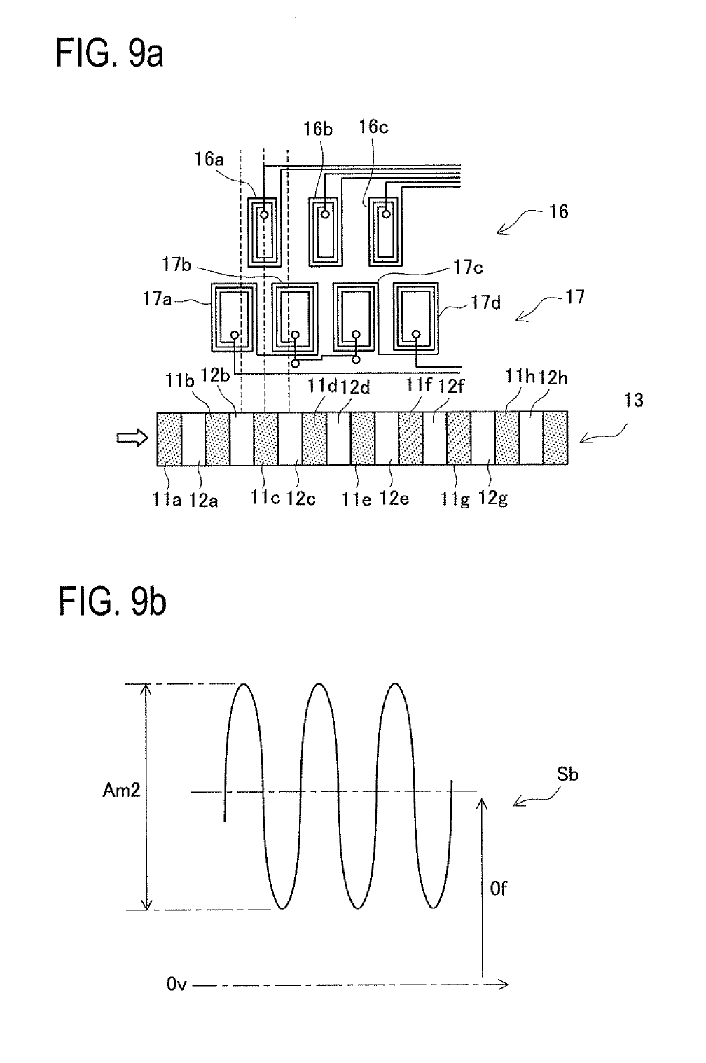

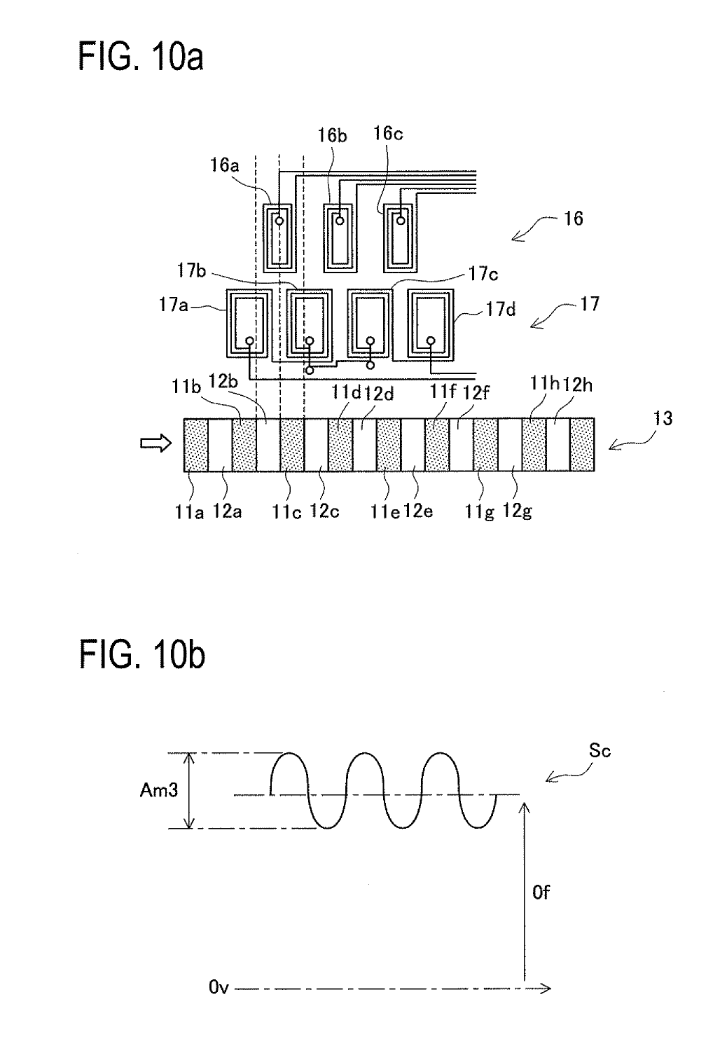

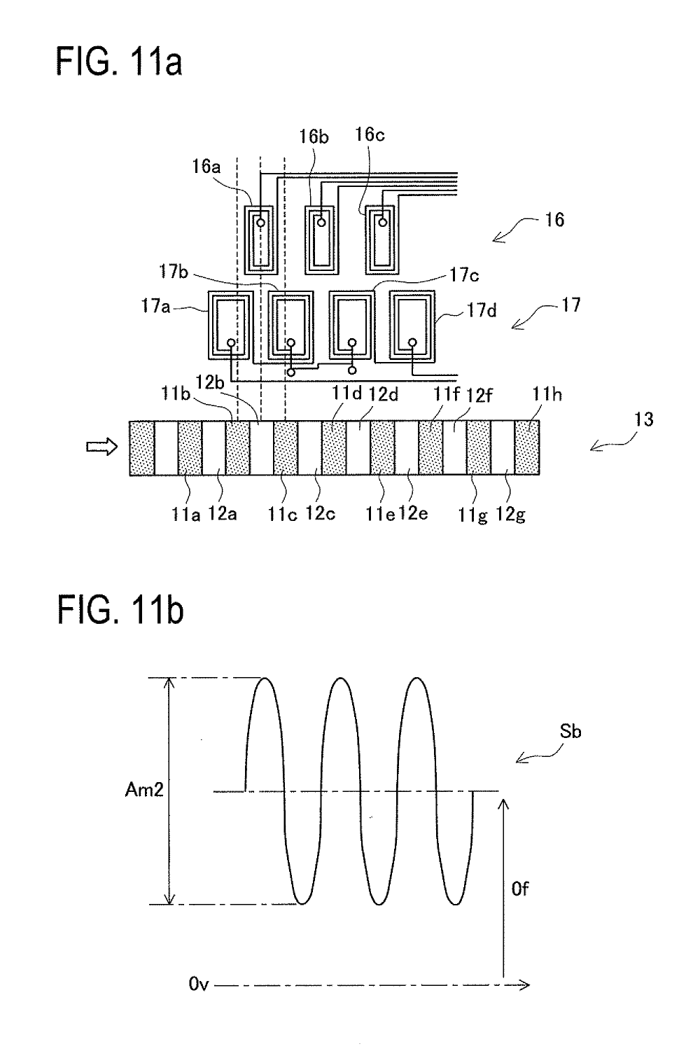

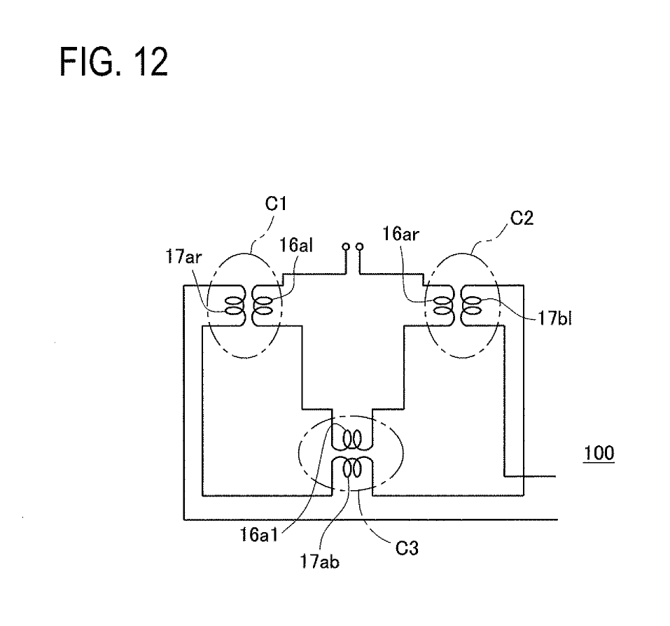

FIG. 8a shows a positional relationship between the rotor 10 and the stator 9. FIG. 8b shows an output waveform S obtained in FIG. 8a. FIG. 9a shows another positional relationship between the rotor 10 and the stator 9. FIG. 9b shows the output waveform obtained in FIG. 9a. FIG. 10a shows another positional relationship between the rotor 10 and the stator 9. FIG. 10b shows the output waveform S obtained in FIG. 10a. FIG. 11a shows another positional relationship between the rotor 10 and the stator 9. FIG. 11b shows the output waveform S obtained in FIG. 11a. FIG. 12 shows an equivalent circuit related to the excitation coil and the detection coil. From FIG. 8a to FIG. 11b, the rotor 10 is advanced, or rotated, and the rotor pattern 13 is moved together. Accordingly, the state of the output waveform S obtained in the detection coil 16 changes. For convenience in explaining, the magnetic sections 11 and the non-magnetic sections 12 of the rotor pattern 13 are added with suffixes “a” to “h” each indicating a position. The correspondence relationship between the detection coil 16 and the excitation coil 17 is explained below referring to FIG. 12.

An equivalent circuit 100 is a circuit configured to show an electric current generated when the first detection coil pattern 16a is placed to overlap the first excitation coil pattern 17a and the second excitation coil pattern 17b as shown in FIG. 12. A first coupling part C1 consists of a first-excitation-coil right side 17ar and a first-detection-coil left side 16al facing each other. A second coupling part C2 consists of a second-excitation-coil left side 17bl and a first-detection-coil right side 16ar facing each other. A third coupling part C3 consists of a circuit short side 16ax and the connecting portion 17ab facing each other. Accordingly, when an AC signal is input to the excitation coil 17, in the first detection coil pattern 16a, the first coupling part C1 and the second coupling part C2 are connected to generate an electromotive force in opposite directions, while the first coupling part C1 and the third coupling part C3 are connected to generate an electromotive force in the same direction. Specifically, assuming that the electromotive force in the first coupling part C1 is V1, the electromotive force in the second coupling part C2 is V2, and the electromotive force in the third coupling part C3 is V3, an output V4 of the first detection coil pattern 16a is expressed by: V1−V2+V3.

To be concrete, in the state in FIG. 8a, firstly, the first-excitation-coil right side 17ar is positioned to face the magnetic section 11c. In this state, when a high-frequency sine wave signal is input to the excitation coil 17, a magnetic flux is generated. This magnetic flux generated in the first right side 17ar passes through the magnetic section 11c. Depending on variation in the passing magnetic flux, a large electromotive force is generated in the first-detection-coil left side 16al. The second-excitation-coil left side 17bl is positioned to face the non-magnetic section 12c. Thus, a magnetic flux generated in the second left side 17bl passes through the non-magnetic section 12c. In this non-magnetic section 12c, eddy currents occur in a direction to cancel out this variation in magnetic flux. Thus, a small electromotive force occurs in the first-detection-coil right side 16ar of the detection coil 16. Referring to the equivalent circuit 100 shown in FIG. 12, the electromotive force V1 generated in the first coupling part C1 consisting of the first-excitation-coil right side 17ar and the first-detection-coil left side 16al is increased by passing through the magnetic section 11c, while the electromotive force V2 generated in the second coupling part C2 consisting of the second-excitation-coil left side 17bl and the first-detection-coil right side 16ar is decreased by passing through the non-magnetic section 12c. Therefore, the electromotive force expressed by a difference between V1 and V2 occurs in the equivalent circuit 100. The amplitude Am1 of this electromotive force is maximum. When the electromotive force V3 in the third coupling part C3 is added to the above electromotive force, a waveform Sa offset by an offset width Of from a reference voltage as shown in FIG. 8b is obtained. The circuit short side 16ax and the connecting portion 17ab are arranged so as not to directly overlap each other.

In FIG. 9a showing a state where the rotor pattern 13 is rotated and moved, and the first-excitation-coil right side 17ar is positioned to face a boundary between the magnetic section 11c and the non-magnetic section 12b. The second-excitation-coil left side 17bl is positioned to face a boundary between the magnetic section 11c and the non-magnetic section 12c. Referring to the equivalent circuit 100 in FIG. 12, the electromotive force V1 generated in the first coupling part C1 and the electromotive force generated in the second coupling part C2 become equal in relation to overlapping portions with the non-magnetic section 12b, the magnetic section 11c, and the non-magnetic section 12c. Accordingly, the electromotive force in the equivalent circuit 100, expressed by a difference between V1 and V2, is zero. However, by addition of the electromotive force V3, a waveform Sb having an amplitude Am2 and being offset by an offset width Of from a reference voltage as shown in FIG. 9b is obtained. The amplitude Am2 is smaller than the amplitude Am1.

In FIG. 10a showing a state where the rotor pattern 13 is further rotated and moved, the first-excitation-coil right side 17ar comes to face the non-magnetic section 12b. On the other hand, the second-excitation-coil left side 17bl comes to face the magnetic section 11c. Referring to the equivalent circuit 100 in FIG. 12, the electromotive force V1 generated in the first coupling part C1 decreases due to facing the non-magnetic section 12b, while the electromotive force V2 generated in the second coupling part C2 increases due to facing the magnetic section 11c. Thus, the electromotive force in the equivalent circuit 100, expressed by a difference between V1 and V2, is minus. However, by addition of the electromotive force V3, a waveform Sc having an amplitude Am3 and being offset by an offset width Of from a reference voltage as shown in FIG. 10b is obtained. The amplitude Am3 is minimum. At that time, the coupling size of the third coupling part C3 is adjusted to prevent the output V4 from becoming minus. To be concrete, the coupling size is controlled by adjustment of the distance between the circuit short side 16ax and the connecting portion 17ab and respective lengths.

In FIG 11a showing a subsequent state where the rotor pattern 13 is further rotated and moved, the first-excitation-coil right side 17ar is positioned to face a boundary between the magnetic section 11b and the non-magnetic section 12b, while the second-excitation-coil left side 17bl is positioned to face a boundary between the magnetic section 11c and the non-magnetic section 12b. Referring to the equivalent circuit 100 in FIG. 12, the electromotive force V1 generated in the first coupling part C1 and the electromotive force V2 generated in the second coupling part C2 become equal in relation to overlapping with the non-magnetic section 12b, the magnetic section 11c, and the non-magnetic section 12c. Accordingly, the electromotive force in the equivalent circuit 100, expressed by a difference between V1 and V2, is zero. However, by addition of the electromotive force V3, a waveform Sb having an amplitude Am2 and being offset by an offset width Of from a reference voltage as shown in FIG 11b is obtained.

Although the above explanation is made on the first detection coil pattern 16a, the same applies to the second detection coil pattern 16b and the third detection coil pattern 16c. Specifically, these patterns 16b and 16c can generate output waveforms respectively from the relationship of the second excitation coil pattern 17b, the third excitation coil pattern 17c, and the fourth excitation coil pattern 17d with the magnetic sections 11 and the non-magnetic sections 12. On the other hand, a relationship of the patterns 16b and 16c with respect to the pattern 16a is as shown by the output waveforms S9 and S10 in relation to the output waveform S8 in FIG. 7. This results from that the patterns 16a-16c are spaced from each other at a pitch as large as 2.5 times compared to the pitch between the magnetic sections 11. By action between the circuit short side 16bx of the second detection coil pattern 16b and the connecting portion 17bc and between the circuit short side 16cx of the third detection coil pattern 16c and the connecting portion 17cd, the second detection coil pattern 16b and the third detection coil pattern 16c can obtain the same offset effect as with the first detection coil pattern 16a.

As explained above, according to the movement of the rotor pattern 13, the output waveform of the electromotive force detected by the detection coil 16 is obtained as the output waveforms S8, S9, and S10, and the pulse signal S13 is obtained as a signal A and the pulse signal S14 is obtained as a signal B as explained in the block diagram of FIG. 6. Those signals are a signal with 225° phase shift and a signal with 135° phase shift, as described above. Based on those signals, the stator 9 can detect the rotational position (i.e., angle) of the rotor 10.

The position sensor in the first embodiment configured as above can provide the following operations and effects.

Firstly, the rotary encoder 8 can be provided as the position sensor capable of generating a large amplitude ratio. The rotary encoder 8 in the embodiment includes the stator 9 provided with the excitation coil 17 and the detection coil 16 each formed in planar form, and the rotor 10 placed to face the stator 9 and provided with the magnetic sections 11 and the non-magnetic sections 12 that are alternately and cyclically arranged in the moving direction of the rotor 10. The first detection coil pattern 16a of the detection coil 16 is placed in a position corresponding to between the first excitation coil pattern 17a and the adjacent second excitation coil pattern 17b of the excitation coil 17 in the moving direction of the rotor 10. The second excitation coil pattern 17b is wound to allow excitation current to flow in an opposite direction to a current flow in the first excitation coil pattern 17a.

This configuration can improve the detection accuracy of the rotary encoder 8. This results from the following reasons. The first detection coil pattern 16a is provided in a position corresponding to between the first excitation coil pattern 17a and the second excitation coil pattern 17b in the rotating direction of the rotor 10. Similarly, the second detection coil pattern 16b is provided in a position corresponding to between the second excitation coil pattern 17b and the third excitation coil pattern 17c. The third detection coil pattern 16c is provided in a position corresponding to between the third excitation coil pattern 17c and the fourth excitation coil pattern 17d.

Adjacent coil patterns; i.e., the first excitation coil pattern 17a and the second excitation coil pattern 17b, the second excitation coil pattern 17b and the third excitation coil pattern 17c, and the third excitation coil pattern 17c and the fourth excitation coil pattern 17d, are wound in opposite directions to each other as shown in FIG. 3. Thus, when the excitation coil 17 is excited, the magnetic flux density passing through the magnetic sections 11 continuously changes according to the movement of the rotor 10. In the first detection coil pattern 16a, for example, the magnetic flux generated by the first excitation coil pattern 17a and the magnetic flux generated by the second excitation coil pattern 17b are opposite in direction.

Accordingly, a difference in electromotive force generated in a circuit of the first detection coil pattern 16a becomes large between the case where the magnetic flux passing through the magnetic section 11 is greatly subjected to the influence of the first excitation coil pattern 17a and the case where the magnetic flux passing through the magnetic section 11 is greatly subjected to the influence of the second excitation coil pattern 17b. Thus, a large amplitude ratio can be taken as indicated by the waveform Sa in FIG. 8b.

Furthermore, the S/N ratio of the rotary encoder 8 can be improved. Specifically, the wire portions of the first excitation coil pattern 17a and the second excitation coil pattern 17b on respective sides facing each other are placed in positions overlapping part of wire portions of the first detection coil pattern 16a by interposing an insulating layer (corresponding to the PI film 30 or the substrate 23) therebetween. This can achieve a minimum distance between the detection coil 16 and the detection coil 17. Since the intensity of an electric field becomes weaker in inverse proportion to the distance from the center of wiring, the condition is more deteriorated as the distance between the excitation coil 17 and the detection coil 16 is longer. When the distance between the detection coil 16 and the excitation coil 17 is set to be shorter, the output of electric current detected by the detection coil 16 becomes larger, resulting in improvement of the S/N ratio of the position sensor.

Another effect is a simplified circuit configuration resulting from the offset effect. The position sensor in the present embodiment includes the first to third coupling parts C1 to C3 serving as linking portions to add excitation signal components applied to the excitation coil 17 to detection signals detected by the detection coil 16, and the envelop detectors 41 to 43 connected to the detection coil 16, so that an envelope signal obtained by the detection signal form the detection coil 16 through an envelope detection circuit is used to detect the angle of the rotor 10. The first excitation coil pattern 17a and the second excitation coil pattern 17b are connected in the connecting portion 17ab. The second excitation coil pattern 17b and the third excitation coil pattern 17c are connected in the connecting portion 17bc. The third excitation coil pattern 17c and the fourth excitation coil pattern 17d are connected in the connecting portion 17cd. The corresponding first to third detection coil patterns 16a to 16c are placed with respective short sides overlapping the connecting portions 17ab to 17cd respectively.

Therefore, when electric power is supplied to the excitation coil 17, the power passing through the connecting portions 17ab to 17cd also generate magnetic flux, thereby enhancing the magnetic flux density in the magnetic section 11 to generate the electromotive force in the detection coil 16. This leads to offset of the output waveform S. The electromotive force V3 explained in the equivalent circuit 100 in FIG. 12 is added to the electric power corresponding to a difference between the electromotive force V1 and the electromotive force V2, thereby offsetting the output waveform S to generate the output V4. As a result, waveforms such as the waveforms Sa to Sc shown in FIG. 8b to FIG 11b are obtained. The waveform Sc corresponds to a state where the amplitude of the output waveform S detected by the detection coil 16 is lowest. This waveform Sc indicates the same periodic waveform as the waveform Sa. However, this waveform is likely to be reversed in the absence of offset effect.

In the present embodiment, since the waveform Sa and the waveform Sc are obtained as the same periodic waveforms by the offset effect, the pulse signal S13 and the pulse signal S14 can be obtained by comparison of waveforms without needing any correction circuit. Accordingly, cost reduction of the rotary encoder 8 can be achieved.

Another effect is that the detection accuracy of the position sensor can be improved by the presence of the back yoke 15. The excitation coil 17, detection coil 16, and back yoke 15 are isolated from each other by the PI films 30 and laminated as shown in FIG. 4. The PI films 30 also function to hold the back yoke 15 made of a magnetic material on the flexible printed substrate 23. The magnetic flux generated in the excitation coil 17 passes through the magnetic material of the magnetic section 11 and others. Thus, the magnetic flux density can be increased. This can improve the detection accuracy of the rotary encoder 8.

The back yoke 15 held by the PI film 30 can be prevented from dropping off. This can reduce the amount of a binder to be mixed in the magnetic material in forming the back yoke 15. The binder functions to hold the magnetic material on the flexible printed substrate 23 without allowing drop-off or peel-off, but conversely may cause a deterioration in density of the magnetic material. In the present embodiment using the PI film 30 to hold the back yoke 15, the amount of a binder forming the back yoke 15 can be reduced. As shown in FIGS. 4 and 5, the back yoke 15 is sandwiched between two PI films 30. This configuration enables the PI films 30 to hold the back yoke 15 and also the back yoke 15 to be designed to be thicker as needed. As a result, the back yoke 15 can further enhance the effect to increase the magnetic flux density generated in the excitation coil 17. This leads to improvement of detection accuracy of the rotary encoder 8.

A second embodiment of the present invention will be described below. The second embodiment substantially identical in configuration to the first embodiment excepting a circuit configuration of the position sensor. Thus, the following explanation is focused on the differences from the first embodiment.

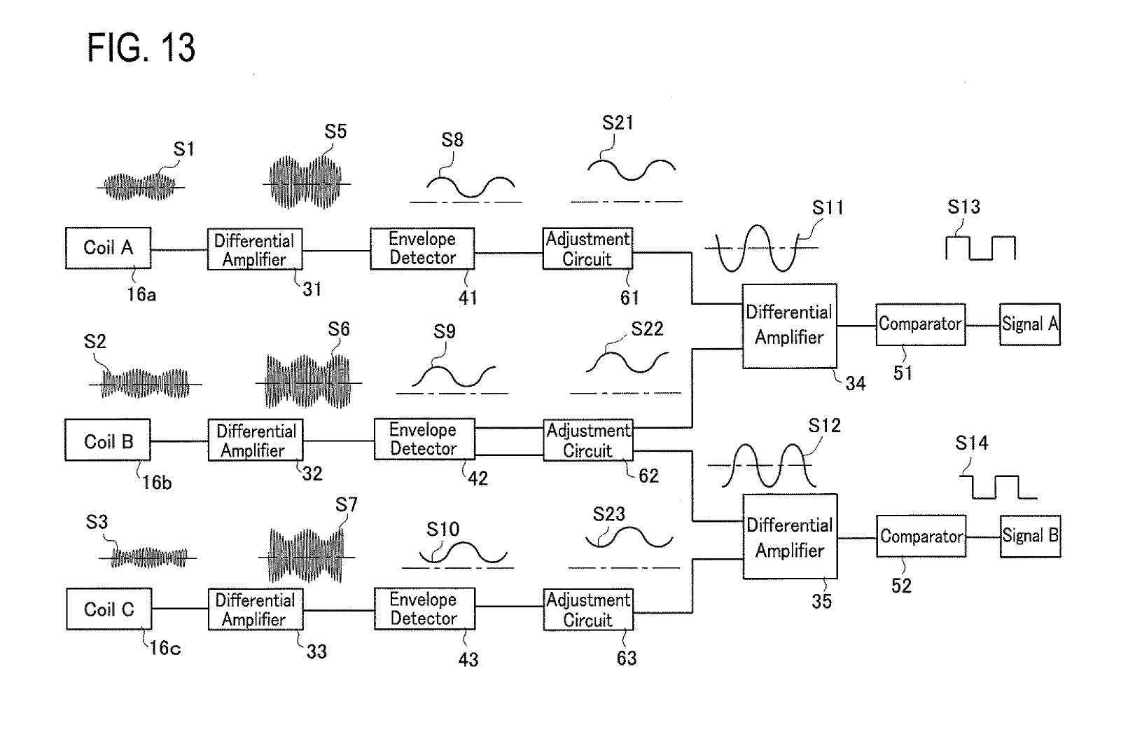

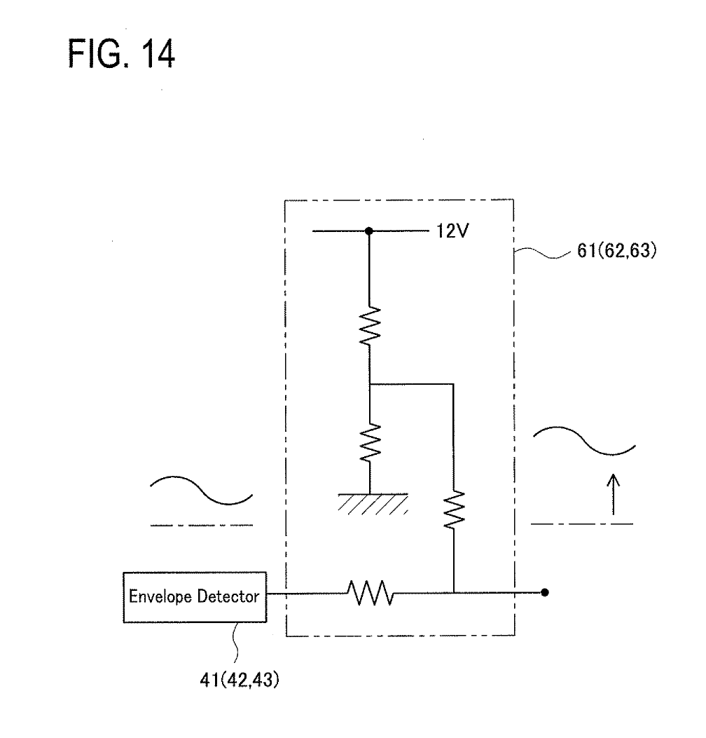

FIG. 13 is a detection block diagram of a rotary encoder 8 of the second embodiment. FIG. 14 is a conceptual diagram of adjustment circuits. A adjustment circuit 61 is provided to inject a DC component into an output waveform S8. When the DC component is injected into the output waveform S8, the position of the output waveform S8 is offset. The adjustment circuit 61 is placed following the envelop detector 41 as shown in FIG. 13 and connects a DC component of 12V to a circuit as shown in FIG. 14. Accordingly, an offset waveform S21 is obtained from the output waveform S8. Similarly, an adjustment circuit 62 is placed following the envelop detector 42 to offset an output waveform S9, generating an offset waveform S22. Further, an adjustment circuit 63 is placed following the envelop detector 43 to offset an output waveform S10, generating an offset waveform S23.

The position sensor of the second embodiment configured as above can provide the following operations and effects.

Following the envelop detectors 41 to 43 provided in the circuit of the rotary encoder 8, the adjustment circuits S61 to S63 are respectively arranged to adjust the offset value of each signal formed by addition of the excitation signal component. Since the detection coil patterns have a limitation in manufacturing accuracy, in a case where the rotary encoder 8 includes a plurality of detection coils 16, the offset value is not easily finely adjusted. In such a case, addition of the adjustment circuits 61 to 63 enables the fine adjustment and contributes to improvement of the detection accuracy of the position sensor.

The offset waveforms S21 and S22 are added up in the differential amplifier 34, finally forming a pulse signal S13 via the comparator 51. The offset waveform S22 and the offset waveform S23 are added up in the differential amplifier 35, finally forming a pulse signal S14 via the comparator 52. The thus obtained pulse signals S13 and S14 have respective offset levels of the output waveforms S8 to S10 adjusted in the adjustment circuits 61 to 63.

Since the offset levels of the output waveforms S8 to S10 are individually adjusted, different adjustment from the adjustment in the third coupling part C3 can be carried out. This can contribute to improvement of the detection accuracy of the rotary encoder 8. To adjust the offset positions of the output waveforms S8 to S10, it is necessary to enhance drawing precision of the detection coil 16 and excitation coil 17. In some cases, moreover, high-precise positional adjustment is required beyond a manufacturable accuracy limitation. Using the adjustment circuits 61 to 63 helps this drawing precision and enables the fine adjustment. This fine adjustment contributes to further improvement of detection accuracy of the rotary encoder 8. In the second embodiment, the adjustment circuit 61 is placed following the envelop detector 41, the adjustment circuit 62 is placed following the envelop detector 42, and the adjustment circuit 63 is placed following the envelop detector 43. An alternative may be configured such that one of the envelop detectors 41 to 43 is used as a reference and one of the adjustment circuits 61 to 63 is eliminated. This configuration can also provide the same effects as above.

A third embodiment of the present invention will be described below. The third embodiment is substantially identical in configuration to the first embodiment excepting a circuit configuration of the position sensor. The following explanation is focused on the differences from the first embodiment.

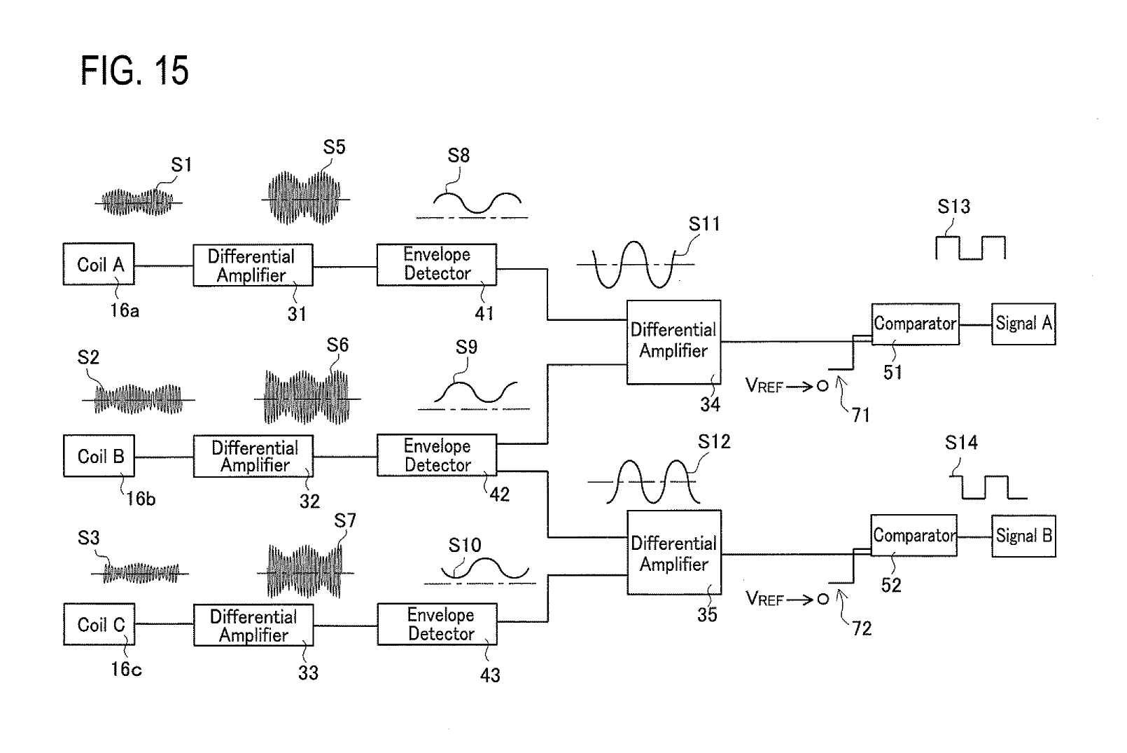

FIG. 15 is a detection block diagram of a rotary encoder 8 of the third embodiment. In the third embodiment, instead of the adjustment circuits 61 to 63 used in the second embodiment, adjustment circuits 71 and 72 are used to offset waveforms. As the adjustment circuit 71, a reference voltage V_{REF} is input to the comparator 51. As the adjustment circuit 72, a reference voltage V_{REF} is input to the comparator 52.

The position sensor of the third embodiment configured as above can provide the following operations and effects.

A signal S11 is generated from the output waveforms S8 and S9 each of which is displaced from a reference position and input to the differential amplifier 34. Thus, the output waveform S8 is expressed by “Sin θ+Va (offset value)” and the output waveform S9 is expressed by “Sin(θ+90)+Vb (offset value)”. These offset values Va and Vb result from accuracy errors that occur in manufacture of the detection coil 16 and the excitation coil 17. When the output waveforms S8 and S9 are input to the differential amplifier 34, the resultant signal S11 expressed by “Sin(θ+90)−Sin θ+Vb−Va” is output. Actually, a signal expressed by “Sin(θ+90)−Sin θ” is desired. Thus, when a voltage equivalent to “Vb−Va” is input as the reference voltage V_{REF} to the comparator 51, an offset deviation can be corrected in theory. When the same processing is also carried out in the comparator 52, the pulse signals S13 and S14 are finally obtained with less errors. This can improve the detection accuracy of the rotary encoder 8.

A fourth embodiment of the present embodiment will be described below, referring to the accompanying drawings. The fourth embodiment is similar in configuration to the first embodiment excepting a circuit configuration of the position sensor. The following explanation is focused on the differences from the first embodiment.

As mentioned in the Problems to be solved by the invention, if size reduction and cost reduction are pursued, it is conceivable to adopt the method using a high-frequency signal as disclosed in Patent Document 2. This can reduce the number of turns of each coil pattern. However, as the number of turns of each coil pattern is reduced, a difference in length of coil wires and others may greatly influence a detection signal and affect the detection accuracy. Patent Documents 1 to 3 fail to mention those problems. It is also conceivable to for example incorporate a correction circuit for correcting a detection signal. However, such addition of an extra circuit hinders cost reduction. Furthermore, installation of correction circuits one each for coil patterns may cause a large limitation of installation space. This method is therefore not preferable. In the fourth embodiment according to the present invention, to solve the above problems, there is provided an inexpensive position sensor arranged to give an offset effect to output waveforms obtained by a detection coil by a simple method.

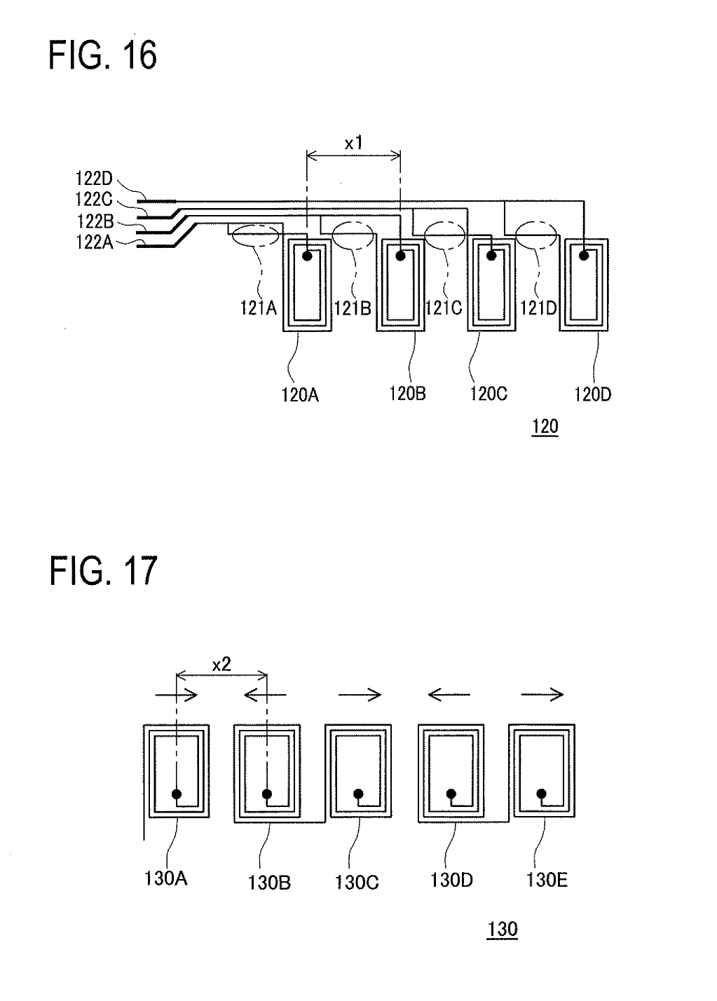

FIG. 16 is a plan view of a detection coil 120. FIG. 17 is a plan view of an excitation coil 130. The detection coil 120 and the excitation coil 130 each consist of coil patterns made of a high-conductive material. Each coil pattern is formed of a conductive wire portion wound in spiral form by a little less than three turns. The coil patterns in the fourth embodiment are formed by drawing such as screen printing and inkjet printing. Any other techniques to form the coil patterns may also be adopted.

The detection coil 120 consists of a plurality of coil patterns arranged side by side, which are referred to as a first detection coil pattern 120A, a second detection coil pattern 120B, a third detection coil pattern 120C, and a fourth detection coil pattern 120D. The first pattern 120A is connected to a first output terminal 122A via a first connecting wire 121A. The second pattern 120B is placed adjacent to the first pattern 120A at a predetermined interval therefrom, and is connected to a second output terminal 122B via a second connecting wire 121B. The third pattern 120C is placed adjacent to the second pattern 120B at the predetermined interval therefrom, and is connected to a third output terminal 122C via a third connecting wire 121C. The fourth pattern 120D is placed adjacent to the third pattern 120C at the predetermined interval therefrom, and is connected to a fourth output terminal 122D via a fourth connecting wire 121D. The predetermined interval is defined as a detection coil interval X1.

The excitation coil 130 includes a first excitation coil pattern 130A, a second excitation coil pattern 130B, a third excitation coil pattern 130C, a fourth excitation coil pattern 130D, and a fifth excitation coil pattern 130E arranged in line. Each pair of the adjacently arranged excitation coil patterns; the first and second patterns 130A and 130B, the second and third patterns 130B and 130C, the third and fourth patterns 130C and 130D, and the fourth and fifth patterns 130D and 130E, is formed to allow electric current to flow in different directions and the adjacent patterns are spaced apart at a predetermined interval defined as an excitation coil internal X2.

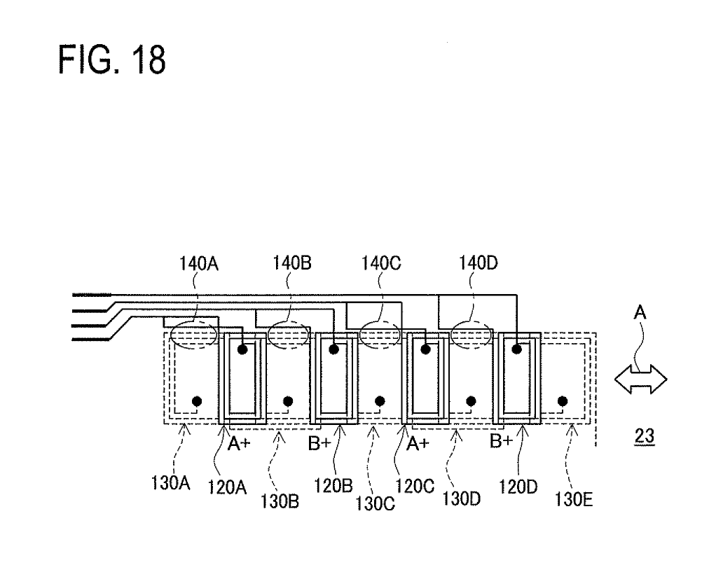

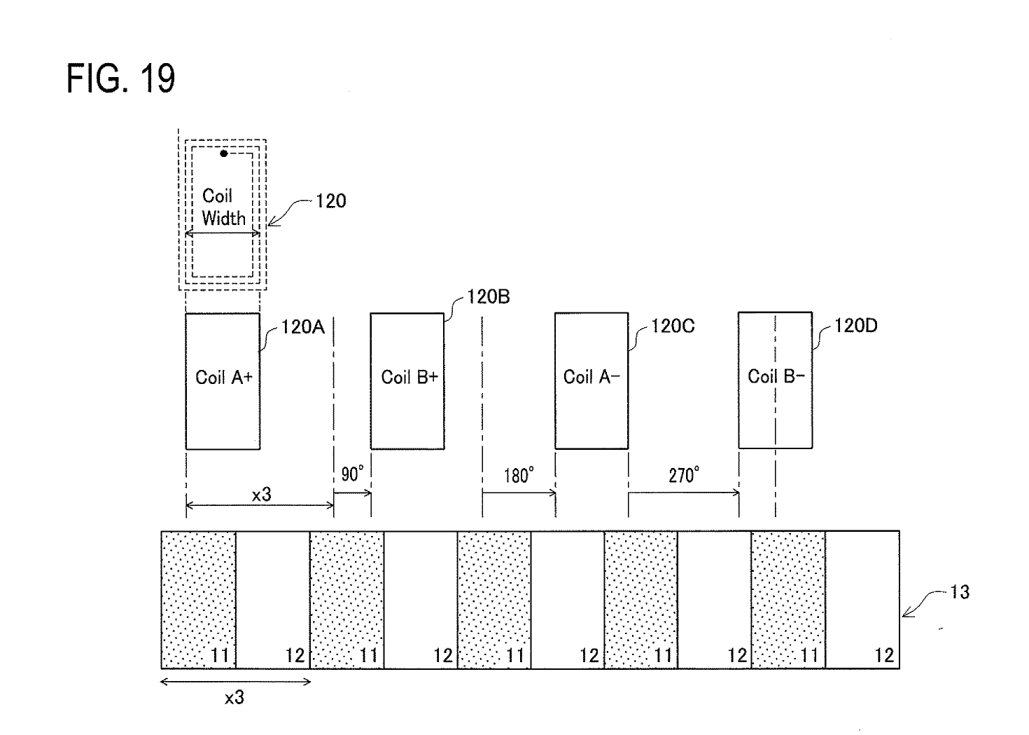

FIG. 18 is a plan view showing a state where the detection coil 120 and the excitation coil 130 are placed in overlapping manner by interposing the flexible printed substrate 23 therebetween. FIG. 19 is a plan view showing correspondence between the detection coil 120 and the rotor pattern 13. The detection coil 120 and the excitation coil 130, each configured as above, are formed on the flexible printed substrate 23 as shown in FIG. 18. When the detection coil 120 and the excitation coil 130 are positioned one on the other, center wire portions in one side of each coil pattern, the one side being perpendicular to a rotation direction A, coincide with one another. This is because the detection coil internal X1 and the excitation coil interval X2 are set to be equal.

Since the detection coil 120 and the excitation coil 130 are placed one on the other, a first coupling part 140A is provided where the first connecting wire 121A continuous to the first detection coil pattern 120A and a short side of the first excitation coil pattern 130A run in parallel. A second coupling part 140B is provided where the second connecting wire 121B continuous to the second detection coil pattern 120B and a short side of the second excitation coil pattern 130B run in parallel. A third coupling part 140C is provided where the third connecting wire 121C continuous to the third detection coil pattern 120C and a short side of the third excitation coil pattern 130C run in parallel. Furthermore, a fourth coupling part 140D is provided where the fourth connecting wire 121D continuous to the fourth detection coil pattern 120D and a short side of the fourth excitation coil pattern 130D run in parallel.

The detection coil 120 adopts a four-signal detection method. Accordingly, as shown in FIG. 19, the first detection coil pattern 120A is set as a coil A+ with a phase shift of 0°. The second detection coil pattern 120B is set as a coil B+ with a phase shift of 90°. The third detection coil pattern 120C is set as a coil A− with a phase shift of 180°. The fourth detection coil pattern 120D is set as a coil B− with a phase shift of 270°. The total width of one magnetic section 11 and one non-magnetic section 12 is an electric angle X3 defined as 360°. Thus, the second detection coil pattern 120B is shifted in phase by 90° from the electric angle X3, the third detection coil pattern 120C is shifted in phase by 180° from the electric angle X3, and the fourth detection coil pattern 120D is shifted in phase by 270° from the electric angle X3.

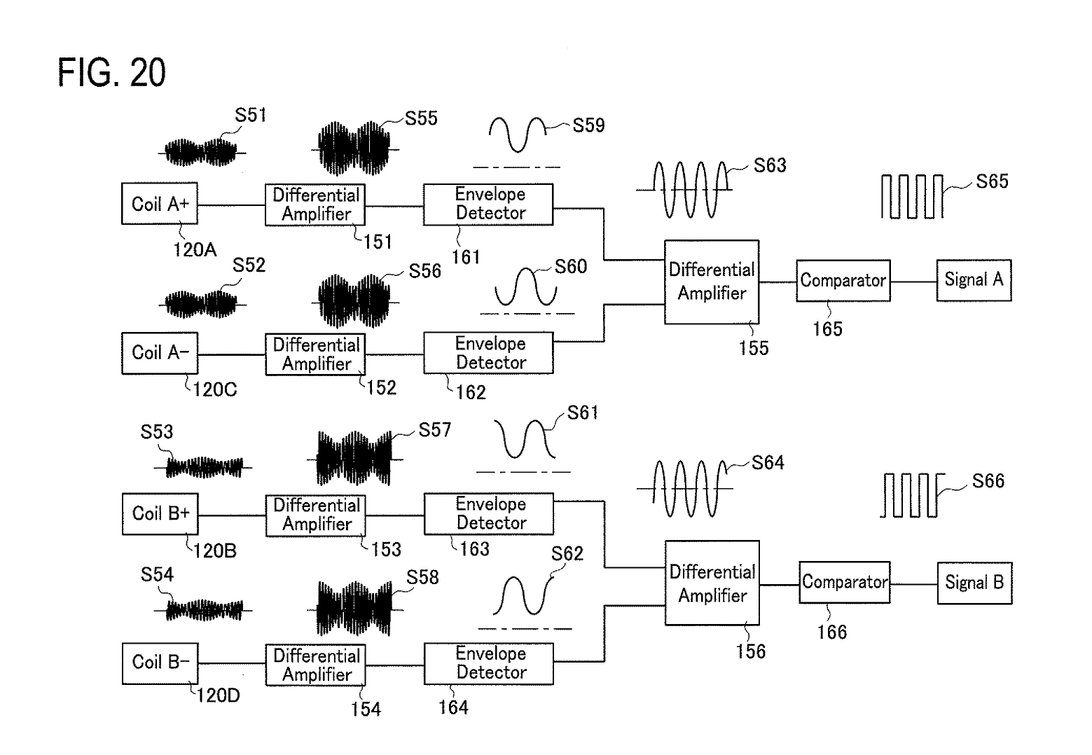

FIG. 20 is a detection block diagram of the rotary encoder 8 of the present embodiment. A high-frequency sine wave of about 2 MHz is input to the excitation coil 130. This makes it possible to reduce the number of turns of the excitation coil 130. A terminal of the first detection coil pattern 120A is connected to the differential amplifier 151 to input a signal S51 into a differential amplifier 151. This differential amplifier 151 differentially amplifies the signal S51 to generate a signal S55. The third detection coil pattern 120C is connected to a differential amplifier 152 to input a signal S52 to the differential amplifier 152. The second detection coil pattern 120B is connected to a differential amplifier 153 to input a signal S53 to the differential amplifier 153. The fourth detection coil pattern 120D is connected to a differential amplifier 154 to input a signal S54 to the differential amplifier 154.

An outer envelope of the high-frequency signal S55 obtained by the differential amplifier 151 is envelope detected at an envelope detector 161 to produce a signal S59. Similarly, a high-frequency signal S56 obtained by the differential amplifier 152, a high-frequency signal S57 obtained by the differential amplifier 153, and a high-frequency signal S58 obtained by the differential amplifier 154 are respectively input to the envelop detectors 162, 163, and 164 to produce signals S60, S61, and S62. These signals S60, S61, and S62 are respectively shifted in phase by 180°, 90°, and 270° relative to the signal S59. These phase shifts result from the arrangement of the first to fourth detection coil patterns 120A to 120D as shown in FIG. 19.

The output waveform S59 of the envelop detector 161 and the output waveform S60 of the envelop detector 162 are input to and differentially amplified at the differential amplifier 155 to generate a signal S63. The signal S63 is input to a comparator 165 to provide a signal S65, The output waveform S61 of the envelop detector 163 and the output waveform S62 of the envelop detector 164 are input to and differentially amplified at the differential amplifier 156 to generate a signal S64. This signal S64 is input to a comparator 166 to provide a pulse signal S66. By using the pulse signals S65 and S66, the rotation angle of the rotor 10 relative to the stator 9 can be calculated.

The rotary encoder 8 which is the position sensor in the fourth embodiment is configured as above and thus can provide the following operations and effects.

Firstly, an offset effect can be given to current waveforms by a simple circuit configuration. This advantage is obtained by the following configuration. Specifically, the rotary encoder 8 includes the stator 9 on which the planar excitation coil 130 and the planar detection coil 120 are laminated, and the rotor 10 placed to face the stator 9 and having a magnetic characteristic variable in a moving direction on a surface facing the stator 9. The excitation coil 130 includes the first and second excitation coil patterns 130A and 130B each formed in winding shape to allow excitation current to flow in opposite directions to each other. The detection coil 120 includes the first detection coil pattern 120A placed between the first and second patterns 130A and 130B in the moving direction of the rotor 10. As the rotor 10 moves, the output of the first detection coil pattern 120A varies when due to coupling changes of the first detection coil pattern 120A to the first excitation coil pattern 130A and the second excitation coil pattern 130B. In this rotary encoder 8, the first coupling part 140A is provided in which the first connecting wire 121A connecting the first detection coil pattern 120A to the first output terminal 122A runs in parallel to the first excitation coil pattern 130A.

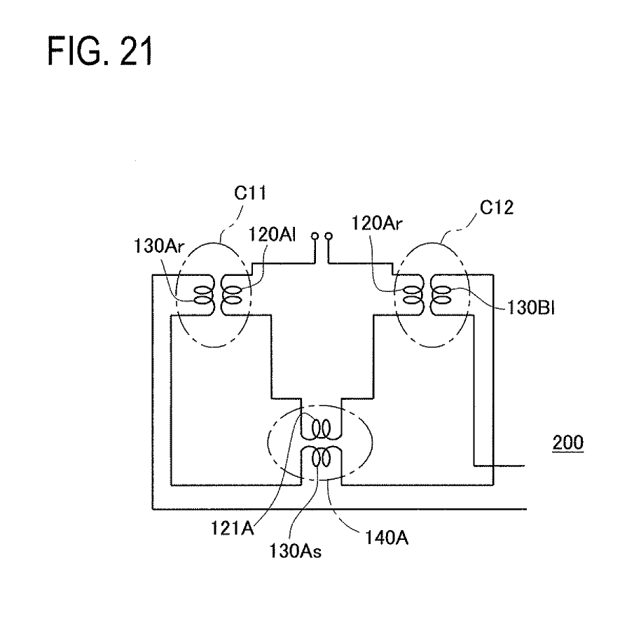

FIG. 21 is an equivalent circuit diagram related to the excitation coil 130 and the detection coil 120. FIG. 21 shows an equivalent circuit 200 configured to show an electric current generated in the first detection coil pattern 120A under the influence of the magnetic section 11 and the non-magnetic section 12 while the first detection coil pattern 120A is placed to overlap the first and second excitation coil patterns 130A and 130B. A left-side coupling part C11 is provided where a first-excitation-coil right side 130Ar and a first-detection-coil left side 120Al face each other. A right-side coupling part C12 is provided where a second-excitation-coil left side 130Bl and a first-detection-coil right side 120Ar face each other. A first coupling part 140A is provided where a first connecting wire 121A and a first excitation coil short side 130As face each other.

Accordingly, in the first detection coil pattern 120A, when an AC signal is input to the excitation coil 130, the left-side coupling part C11 and the right-side coupling part C12 are connected to generate electromotive forces in opposite directions and the left-side coupling part C11 and the first coupling part 140A are connected to generate electromotive forces in the same direction. Specifically, assuming that the electromotive force in the left-side coupling part C11 is V1, the electromotive force in the right-side coupling part C12 is V2, and the electromotive force in the first coupling part 140A is V3, the output V4 of the first detection coil pattern 120A is equal to a result obtained by an expression: V1−V2+V3. In other words, the output V4 is obtained with an offset by the electromotive force V3 of the first coupling part 140A.

This electromotive force V3 is regulated by changing the length of the first connecting wire 121A. This length of the first connecting wire 121A is relatively easily changed as shown in FIG. 16. Thus, the rotary encoder 8 of the fourth embodiment can easily adjust the offset value at the first detection coil pattern 120A. The same applies to the second to fourth detection coil patterns 120B to 120D. Therefore, the offset effect can be given at low cost and contribute to cost reduction of the rotary encoder 8.

The first to fourth connecting wires 121A to 121D can be designed to respective arbitral lengths and thus can be set respectively according to the coil patterns of the first to fourth detection coil patterns 120A to 120D. This makes it possible to adjust variations in output amplitude to be obtained from the first to fourth coupling parts 140A to 140D. This adjustment can be achieved by changing the lengths of the first to fourth connecting wires 121A to 121D and therefore contribute to further cost reduction of the rotary encoder 8 as compared to a configuration additionally including a correction circuit.

The first detection coil pattern 120A and the second detection coil pattern 120B are spaced apart at the detection coil internal X1 The first excitation coil pattern 130A, the second excitation coil pattern 130B, and the third excitation coil pattern 130C are also spaced apart from respective adjacent ones at the excitation coil interval X2. The detection coil interval X1 and the excitation coil interval X2 are set to equal in length. As a result, the detection coil 120 and the excitation coil 130 are arranged so that respective coil patterns are placed alternately in overlapping manner as shown in FIG. 18.

At that time, in the adjacent first and second excitation coil patterns 130A and 130B, electric current is allowed to flow in opposite directions. Similarly, in the adjacent second and third excitation coil patterns 130E and 130C, electric current is allowed to flow in opposite directions. A right long side of the first excitation coil pattern 130A and a left long side of the first detection coil pattern 120A are linked to each other. A left long side of the second excitation coil pattern 130B and a right long side of the first detection coil pattern 120A are linked to each other. A right long side of the second excitation coil pattern 130B and a left long side of the second detection coil pattern 120B are linked to each other. A left long side of the third excitation coil pattern 130C and a right long side of the second detection coil pattern 120B are linked to each other. The left long side and the right long side of the second excitation coil pattern 130B respectively generate electromotive forces to the first detection coil pattern 120A and the second detection coil pattern 120B. Accordingly, the lateral width of each of the detection coil 120 and the excitation coil 130 is set to be narrow. This configuration can contribute to size reduction of the rotary encoder 8.

A fifth embodiment of the present invention will be described below. The fifth embodiment is substantially identical in configuration to the rotary encoder 8 of the fourth embodiment excepting a Z-phase excitation coil, a Z-phase detection coil, and a Z-phase detecting region provided in addition to the detection coil 120 and the excitation coil 130. This configuration of the first embodiment can solve the same problems, as with the fourth embodiment.

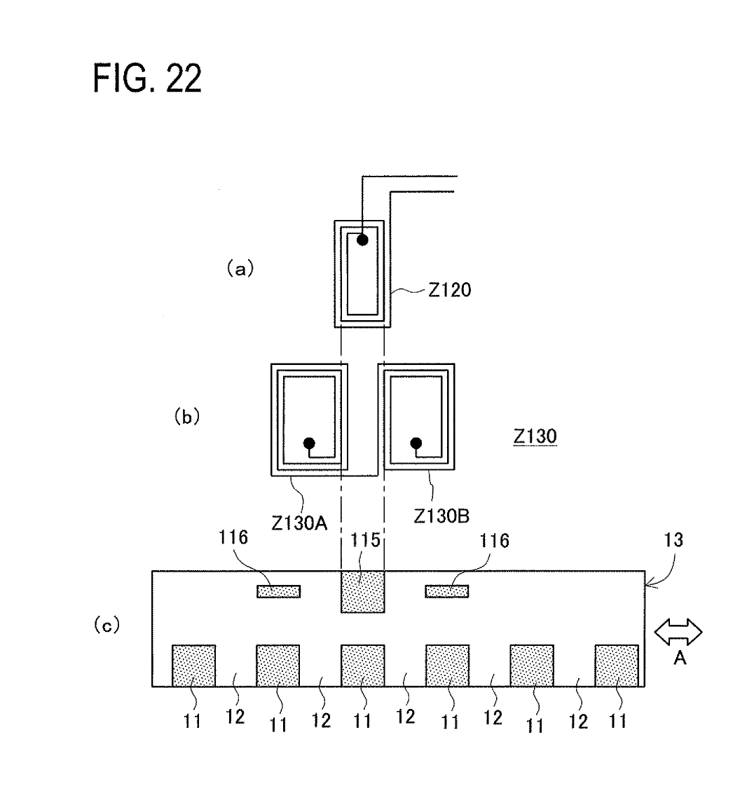

FIG. 22 is a schematic diagram showing a Z-phase detection configuration in the fifth embodiment, in which (a) is a plan view of the Z-phase detection coil, (b) is a plan view of the Z-phase excitation coil, and (e) is a plan view of a rotor pattern. A Z-phase detection coil Z120 is configured, as with the detection coil 120, such that a wire is wound by a little less than three turns. A Z-phase excitation coil Z130 includes a Z-phase first excitation coil pattern Z130A and a Z-phase second excitation coil pattern Z130B so that these patterns Z130A and Z1308 allow electric currents to flow in opposite directions.

As in the fourth embodiment, the rotor pattern 13 is formed with the magnetic sections 11 and the non-magnetic sections 12. In addition, a Z-phase detecting region 115 and Z-phase preliminary detecting regions 116 are provided adjacently to the row of the magnetic sections 11 and the non-magnetic sections 12 alternately arranged. The Z-phase detecting region 115 is located between the Z-phase preliminary detecting regions 116. As shown in FIG. 22(c), the width of each preliminary detecting region 116 is set narrower than the width of the detecting region 115 in a direction perpendicular to a rotor rotating direction A. The Z-phase detection coil Z120 and the Z-phase excitation coil Z130 are placed on the flexible printed substrate 23 to face the Z-phase detecting region 115 and the Z-phase preliminary detecting regions 116. Accordingly, the Z-phase detecting region 115 and the Z-phase preliminary detecting regions 116 have different magnetic permeability from that of the non-magnetic sections 12.

The rotary encoder 8 of the fifth embodiment configured as above can provide the following operations and effects.

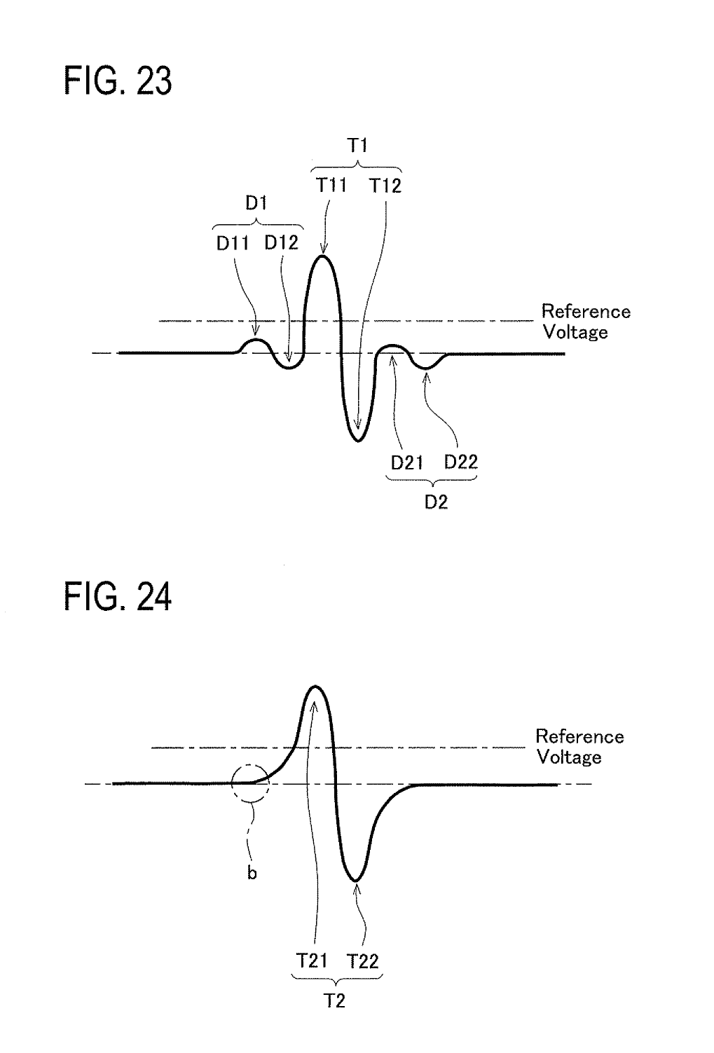

FIG. 23 is a graph showing an output waveform from the Z-phase detection coil Z120 in the fifth embodiment. FIG. 24 is a graph showing an output waveform from a Z-phase detection coil prepared for comparison. In the rotary encoder 8 of the fifth embodiment, the Z-phase excitation coil Z130 firstly passes across one of the Z-phase preliminary detecting regions 116. Thus, the magnetic flux generated around the coil patterns of the Z-phase excitation coil Z130 is enhanced by the Z-phase preliminary detecting region 116, thereby generating an electromotive force in the Z-phase detection coil Z 120. However, the area of the Z-phase preliminary detecting region 116 is narrow and hence a first peak D11 representing a rising edge of a dummy pattern output D1 does not so rise, as shown in FIG. 23.

Thereafter, the non-magnetic section 12 formed between the Z-phase preliminary detecting region 116 and the Z-phase detecting region 115 detects a second peak D12 representing a falling edge of the dummy pattern output D1. Then, under the influence of the Z-phase preliminary detecting regions 116, a first peak T11 and a second peak T12 of the trigger signal T1 are detected by the Z-phase detection coil Z 120. The other one of Z-phase preliminary detecting regions 116 is then detected. Thus, a third peak D21 and a fourth peak D22 of a dummy pattern output D2 are detected by the Z-phase detection coil Z120.

On the other hand, in the case shown in FIG. 24 prepared for comparison, including only the Z-phase detecting region 115 but no Z-phase preliminary detecting region 116, a first peak T21 and a second peak T22 of a trigger signal T2 rise smoothly as shown in FIG. 24. As seen in FIG. 24, in a rising portion b, the signal slowly rises at an early stage. In the comparative case shown in FIG. 24, therefore, the timing of trigger detection is apt to delay. In the present embodiment, in contrast, including the Z-phase preliminary detecting regions 116 on both sides of the Z-phase detecting region 115, the trigger signal Ti sharply rises, so that the timing of Z-phase detection is less likely to delay.

According to the rotary encoder 8 of the fifth embodiment including the Z-phase preliminary detecting regions 116 placed on both sides of the Z-phase detecting region 115, the detection accuracy of the trigger signal T1 obtained by the Z-phase detection coil Z120 can be increased. Since the trigger signal Ti is used for timing correction of the output waveform to be detected from the detection coil 120, the accuracy of the rotary encoder 8 can be finally improved.

The present invention is explained in the above embodiments but is not limited thereto. The invention may be embodied in other specific forms without departing from the essential characteristics thereof. For instance, the aforementioned materials may be replaced with other materials having necessary functions to achieve the purpose of the invention.

For instance, the stator 9 in the first through third embodiments includes three detection coils 16 and four excitation coils 17, and the stator 9 in the fourth and fifth embodiments includes four detection coils 16 and four excitation coils 17. However, the number of coils is not limited to above. A method for manufacturing the detection coil 16 and the excitation coil 17 is not limited to the method using a printed substrate and is selectable from other manufacturing methods such as inkjet drawing.

Furthermore, the back yoke 15 may be formed in an embedded state in the stator main body 26. The detection coil 16 and the excitation coil 17 may be replaced in position on the flexible printed substrate 23, that is, the detection coil 16 is placed on an upper surface of the substrate 23 and the excitation coil 17 is placed on a lower surface of the substrate 23 in FIG. 4. As another alternative, the detection coil 16 and the excitation coil 17 may be placed on one of the surfaces of the substrate 23 to form two layers. In this case, the back yoke 15 is formed on an opposite side of the substrate 23 from a side on which the detection coil 16 and the excitation coil 17 are placed. The coil patterns of the detection coil 120 and the excitation coil 130 may also be formed by a method known as the technique of forming a printed substrate.

### REFERENCE SINGS LIST

8 Rotary encoder
9 Stator
10 Rotor
11 Magnetic section
12 Non-magnetic section
13 Rotor pattern
15 Back yoke
16 Detection coil
17 Excitation coil
23 Flexible printed substrate
24 Mounting member
25 Circuit member
26 Stator main body
30 PI film
31, 32, 33, 34, 35 Differential amplifier
41, 42, 43 Envelope detector
51, 52 Comparator
61, 62, 63, 71, 72 Adjustment circuit
100, 200 Equivalent circuit
115 Z-phase detecting region
116 Z-phase preliminary detecting region
120 Detection coil
130 Excitation coil
151, 152, 153, 154, 155, 156 Differential amplifier
161, 162, 163, 164 Envelope detector
165, 166 Comparator
Am1, Am2, Am3 Amplitude
C1, C2, C3 First, Second, Third coupling part
D1, D2 Dummy pattern output
Of Offset width
T1, T2 Trigger signal
V1, V2, V3 Electromotive force
V4 Output
V_{REF} Reference voltage
Va, Vb Offset amount
X1 Detection coil interval
X2 Excitation coil interval
X3 Electric angle
Z120 Z-phase detection coil
Z130 Z-phase excitation coil

1. A position sensor comprising: a stator including an excitation coil and a detection coil each formed in planar shape; and a mover placed to face the stator and provided with a plurality of regions having different magnetic permeability from each other and being arranged periodically in a moving direction of the mover,
wherein the excitation coil includes a first excitation coil pattern and a second excitation coil pattern formed adjacent to the first excitation coil pattern,
wherein the detection coil includes a detection coil pattern placed between the first excitation coil pattern and the second excitation coil pattern in the moving direction of the mover, and
wherein the second excitation coil pattern is wound to flow an excitation current in an opposite direction to the first excitation coil pattern.

2. The position sensor according to claim 1, wherein the first excitation coil pattern and the second excitation coil pattern include wire portions facing to each other, the wire portions being located in positions overlapping part of wiring portions of the detection coil pattern by interposing an insulation layer.

3. The position sensor according to claim 1, further including a coupling part to add an excitation signal component applied to the excitation coil to a detection signal to be detected by the detection coil; and
an envelope detector circuit connected to the detection coil,
wherein the position sensor is configured to detect an angle of the mover based on an envelope signal obtained by the detection signal from the detection coil by passing through the envelop detector circuit.

4. The position sensor according to claim 3, further including an adjustment circuit placed following the envelop detector circuit to adjust an offset value of a resultant signal of addition of the excitation signal component.

5. The position sensor according to claim 1, wherein
the excitation coil and the detection coil are formed on a flexible printed substrate,
a magnetic material layer is formed on an opposite side of the flexible printed substrate from a side on which the excitation coil and the detection coil are formed, and
the magnetic material layer is covered by a resin film.

6. A position sensor comprising: a stator on which an excitation coil and a detection coil each formed in planar shape and placed one on the other; and a mover placed to face the stator, the mover being formed with a surface facing the stator so that the surface provides varying magnetic permeability in a moving direction,
the excitation coil includes a first excitation coil pattern and a second excitation coil pattern that are wound to flow excitation current to flow in opposite directions to each other,
the detection coil includes a first detection coil pattern placed between the first excitation coil pattern and the second excitation coil pattern in the moving direction of the mover,
the first detection coil pattern outputs a signal varying according to coupling change between the first detection coil pattern and the first and second excitation coil patterns according to movement of the mover,
wherein the position sensor further includes a first coupling part where a first connecting wire connecting the first detection coil pattern to a first output terminal runs in parallel to the first excitation coil pattern.

7. The position sensor according to claim 6, wherein
the excitation coil includes a third excitation coil wound to flow excitation current in an opposite direction to the second excitation coil pattern,
the detection coil includes a second detection coil pattern placed between the second excitation coil pattern and the third excitation coil pattern in the moving direction of the mover,
the second detection coil pattern outputs a signal varying according to coupling change between the second detection coil pattern and the second and third excitation coil patterns according to movement of the mover, and
the position sensor further includes a second coupling part where a second connecting wire connecting the second detection coil pattern to a second output terminal runs in parallel to the second excitation coil pattern.

8. The position sensor according to claim 7, wherein a coupling amount between the first connecting wire and the first excitation coil in the first coupling part and a coupling amount between the second connecting wire and the second excitation coil pattern in the second coupling part are different from each other.

9. The position sensor according to claim 6, wherein
the excitation coil includes a Z-phase excitation coil provided with a Z-phase first excitation coil pattern and a Z-phase second excitation coil pattern,
the detection coil includes a Z-phase detection coil provided with a Z-phase detection coil pattern,
the mover includes, on a mover substrate made of non-magnetic metal and on a surface facing the Z-phase detection coil, a Z-phase detecting region having a different magnetic permeability from a magnetic permeability of the mover substrate and Z-phase preliminary detecting regions having a different magnetic permeability from the magnetic permeability of the mover substrate, and
the Z-phase preliminary detecting regions are placed on both sides of the Z-phase detecting region in the moving direction of the mover.

10. The position sensor according to claim 2, further including a coupling part to add an excitation signal component applied to the excitation coil to a detection signal to be detected by the detection coil; and
an envelope detector circuit connected to the detection coil,
wherein the position sensor is configured to detect an angle of the mover based on an envelope signal obtained by the detection signal from the detection coil by passing through the envelop detector circuit.

11. The position sensor according to claim 2, wherein
the excitation coil and the detection coil are formed on a flexible printed substrate,
a magnetic material layer is formed on an opposite side of the flexible printed substrate from a side on which the excitation coil and the detection coil are formed, and
the magnetic material layer is covered by a resin film.

12. The position sensor according to claim 3, wherein
the excitation coil and the detection coil are formed on a flexible printed substrate,
a magnetic material layer is formed on an opposite side of the flexible printed substrate from a side on which the excitation coil and the detection coil are formed, and
the magnetic material layer is covered by a resin film.

13. The position sensor according to claim 4, wherein
the excitation coil and the detection coil are formed on a flexible printed substrate,
a magnetic material layer is formed on an opposite side of the flexible printed substrate from a side on which the excitation coil and the detection coil are formed, and
the magnetic material layer is covered by a resin film.
